(19) United States
(12) Patent Application Publication
(10) Pub. No.: US 2004/0039587 A1
(43) Pub. Date: Feb. 26, 2004

(54) Method and system for managing recycling of a product

(76) Inventors: Yuzo Horoshige, Tokyo (JP); Takeshi Nishimoto, Toyokawa (JP); Takashi Kassai, Toyokawa (JP); Masakazu Sakaue, Atsugi (JP); Yoshihiro Adachi, Yachiyo (JP); Junichi Shionoya, Funabashi (JP); Kenji Imai, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/401,966

(22) Filed: Mar. 31, 2003

(30) Foreign Application Priority Data
Jun. 17, 2002 (JP) 2002-175609

(51) Int. Cl. G06F 17/60

(52) U.S. Cl. 705/1; 700/223

(57) ABSTRACT

A recycler that is entrusted with recycling of a used product manages information according to entrustment information provided beforehand so that the product is recycled within a predetermined period of time.

The recycler assigns a management number to a recycling job when the recycler is entrusted with the recycling. As soon as a product arrives, the recycler compares the product arrived with the entrustment information on the product. The received product is sorted out in according to the judgment of the value thereof, and how to recycle the product is managed. The progress of recycling is managed according to how to recycle the product, such as disassembling and mechanical recycling, or it is managed on a product basis or on a component basis after disassembling. If the product is shipped to the second recycler, the third recycler and more in order so that the recycling of the product is further entrusted to them, shipment information and the progress of recycling in the ship-to companies are managed in association with the management number. In addition, time limits of the recycling are also managed. By use of the above-mentioned functions, recycling information is managed.

### BACKGROUND OF THE INVENTION

The present invention relates to recycling of a used product (such as electrical equipment, a bicycle, a motorcycle, and furniture) and components of the product (such as devices and fixtures accompanying the product). More specifically, the present invention relates to a system and a method for managing recycling of a product whereby if recycling of a used product and its components is entrusted to a recycler or a manufacturer that plays a similar role (hereinafter they are designated as recyclers), the product and its components are managed so that they are properly delivered to the recycler and subsequently the recycler properly recycles them.

Conventionally, the recycler that provides recycling services accepts all products and components (hereinafter they are designated as products) that have arrived. Then, the recycler manages the accepted products by themselves so that the products are recycled within an appointed period and a fee is charged according to the recycling services actually performed. This was the conventional way of doing recycling business. If the recycler further entrusts the recycling of the accepted products to another company, it is difficult to associate the result of the recycling returned from the entrusted company with the accepted products on a product basis to manage the accepted products. For this reason, the recycler only manages the recycling of the accepted products by the date of receipt, the date of shipment, etc.

In recycling processes, if the recycling of a product is entrusted to a recycler, what is important for the recycler when managing the recycling is that the payment required for the recycling is properly made, and that the product, the recycling of which is entrusted, is properly recycled. In addition, even if a product is recycled through a plurality of recyclers, it is important to manage the recycling so that the product is properly recycled.

Moreover, it is necessary to complete the recycling of the product within a predetermined period of time.

### SUMMARY OF THE INVENTION

An object of the present invention is to manage the recycling of a used product by paying attention to a flow of the used product when a recycler recycles the used product, resulting in efficient recycling of the product.

In addition, another object of the present invention is to manage the recycling so that a product is properly recycled even if the product is recycled through a plurality of recyclers.

Further, another object of the present invention is to manage the recycling so that it is properly completed within a predetermined period of time.

In order to solve the problems, in the present invention, a recycler that performs recycling services manages information required for recycling. In addition, required information such as information on a discarder of a used product, etc. is exchanged among companies involved in the recycling.

The recycler receives a recycling instruction from the discarder of the used product, or an intermediate handler that has been entrusted with the recycling from the discarder, etc. Then, the recycler manages information to check that the product has arrived according to the instruction and is being recycled.

If the intermediate handler entrusts the recycling to a recycler, the intermediate handler associates its own entrustment information with the actual recycling by the entrusted recycler to manage the recycling on both sides. As a result, on the basis of the progress of the recycling in the entrusted recycler, the intermediate handler can keep track of the progress of recycling of a corresponding entrusted recycling job in the intermediate handler.

### BRIEF DESCRIPTION OF THE DRAWINGS

FIGS. 1(a) and 1(b) are block diagrams illustrating one embodiment according to the present invention;

FIG. 2 is a flowchart illustrating processing of the embodiment according to the present invention;

FIGS. 3(a), 3(b) and 3(c) illustrate examples of data entry windows displayed on a screen;

FIGS. 4(a), 4(b), 4(c), 4(d) and 4(e) illustrate table formats of a database in the entrusted company according to one embodiment;

FIGS. 5(a), 5(b), 5(c), 5(d), 5(e) and 5(f) illustrate table formats of a database in a first recycler as one embodiment;

FIGS. 6(a) and 6(b) illustrate one embodiment of a work instruction of the first recycler;

FIGS. 7(a), 7(b) and 7(c) illustrate examples of windows displayed on the first recycler side;

FIGS. 8(a), 8(b), 8(c), 8(d), 8(e), 8(f) and 8(g) illustrate table formats of a database in the first recycler according to one embodiment;

FIGS. 9(a) and 9(b) illustrate table formats of a database on disassembling by the first recycler as one embodiment;

FIGS. 10(a), 10(b) and 10(c) illustrate one embodiment of a work instruction of the first recycler;

FIGS. 11(a) and 11(b) illustrate examples of shipment entry windows for the first recycler;

FIG. 12 is a flowchart illustrating processing of a second embodiment according to the present invention;

FIG. 13 is a flowchart illustrating processing of a third embodiment according to the present invention;

FIGS. 14(a), 14(b), 14(c), 14(d) and 14(e) illustrate examples of a warning window and an attention window for the first recycler;

FIGS. 15(a), 15(b), 15(c), 15(d) and 15(e) illustrate examples of a warning window and an attention window for a manufacturer;

FIGS. 16(a), 16(b) and 16(c) illustrate table formats of a database in the manufacturer according to one embodiment;

FIG. 17 is a diagram illustrating a first embodiment of an entrusted job management method;

FIG. 18 is a diagram illustrating a second embodiment of the entrusted job management method;

FIG. 19 is a diagram illustrating a third embodiment of the entrusted job management method;

FIG. 20 is a diagram illustrating a fourth embodiment of the entrusted job management method; and

FIG. 21 is a diagram illustrating a fifth embodiment of the entrusted job management method.

### DESCRIPTION OF THE PREFERRED EMBODIMENTS

Preferred embodiments of the present invention will be described with reference to the drawings below.

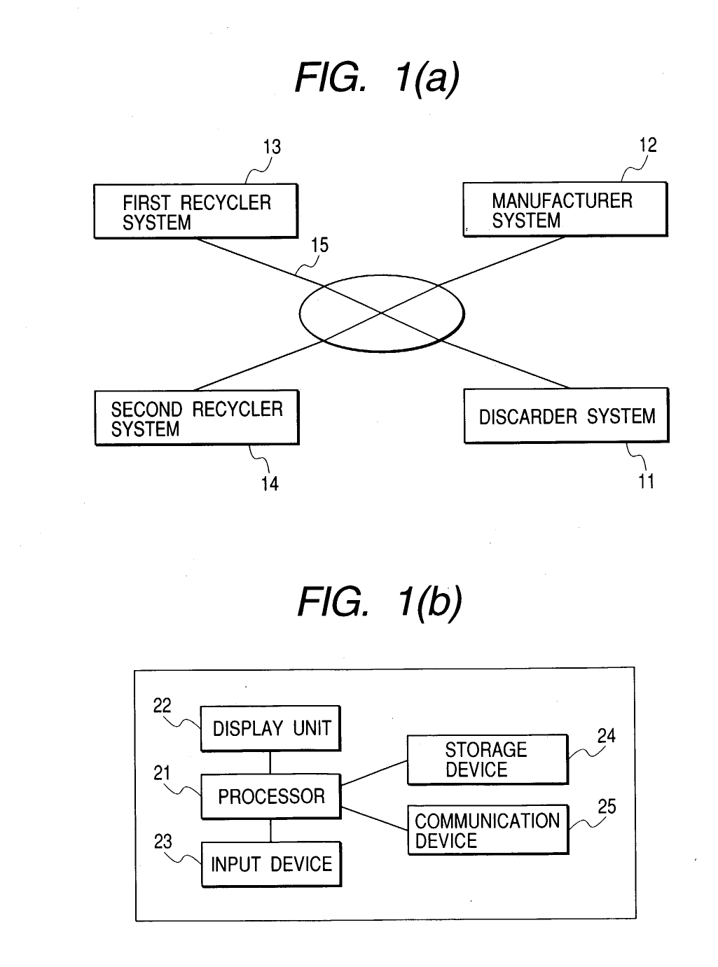

To begin with, a configuration of a recycling management system will be totally described with reference to FIG. 1.

FIGS. 1(a) and 1(b) are a block diagram illustrating one embodiment of the recycling management system. FIG. 1(a) illustrates a configuration of the total recycling management system. FIG. 1(b) illustrates a configuration that is common to all subsystems.

As shown in FIG. 1(a) as an example, this system comprises the following subsystems: a discarder system 11 involving a company or an individual that used a product; a manufacturer system 12 of a manufacturer or an intermediate handler that is entrusted with the recycling of a used product; a first recycler system 13; a second recycler system 14 of a second recycler that is entrusted with part of the recycling by the manufacturer system 12; and a network 15 that interconnects the systems. In general, the recycling management system may include the plurality of discarder systems 11, the plurality of first recycler systems 13, or the plurality of second recycler systems 14. In addition, even if there are not only the second recycler system 14 but also a third recycler system, a fourth recycler system, or more, processing similar to that described in undermentioned embodiments enables realization of the present invention.

Next, a hardware configuration will be described.

If the network 15 is configured as a computer network, each of the systems shown in FIG. 1(a) has a configuration as shown in FIG. 1(b). Each system comprises the following: a processor 21 such as a central processing unit; a display unit 22 such as a display; an input device (an input unit) 23 such as a keyboard, a mouse, and a barcode reader; a storage device (a storage unit) 24 such as a hard disk drive, and a memory; and a communication device (a communication unit) 25 such as a network device.

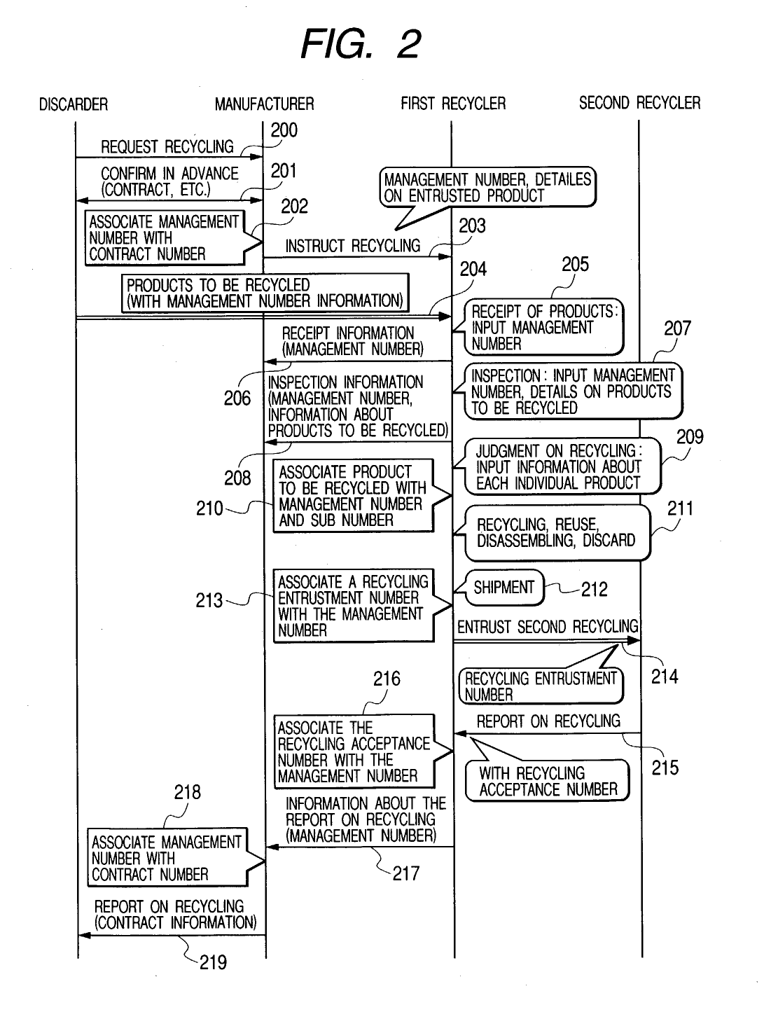

Processing of the recycling management system, and a database required for the processing, will be described with reference to FIGS. 2, 3(a) to 3(c), and 4(a) to 4(e) below.

FIG. 2 is a flowchart illustrating processing of the recycling management system according to a first embodiment. As exemplified in FIG. 2, a user uses a product until the user wish to dispose of the product. When the user discards the product, the user entrusts recycling to a manufacturer in step 201. In this case, the user (that is, a discarder) entrusts the recycling to the manufacturer only when the manufacturer is entrusted with the recycling of used products and the user selects the manufacturer as a company to which the recycling is entrusted. In other cases, the user entrusts the recycling to the first recycler. A case where the user (discarder) entrusts the recycling to the first recycler will be described later.

In this embodiment, a case where a manufacturer that is entrusted with recycling entrusts actual recycling to the first recycler and then the first recycler entrusts part of the recycling to a second recycler will be described as an example.

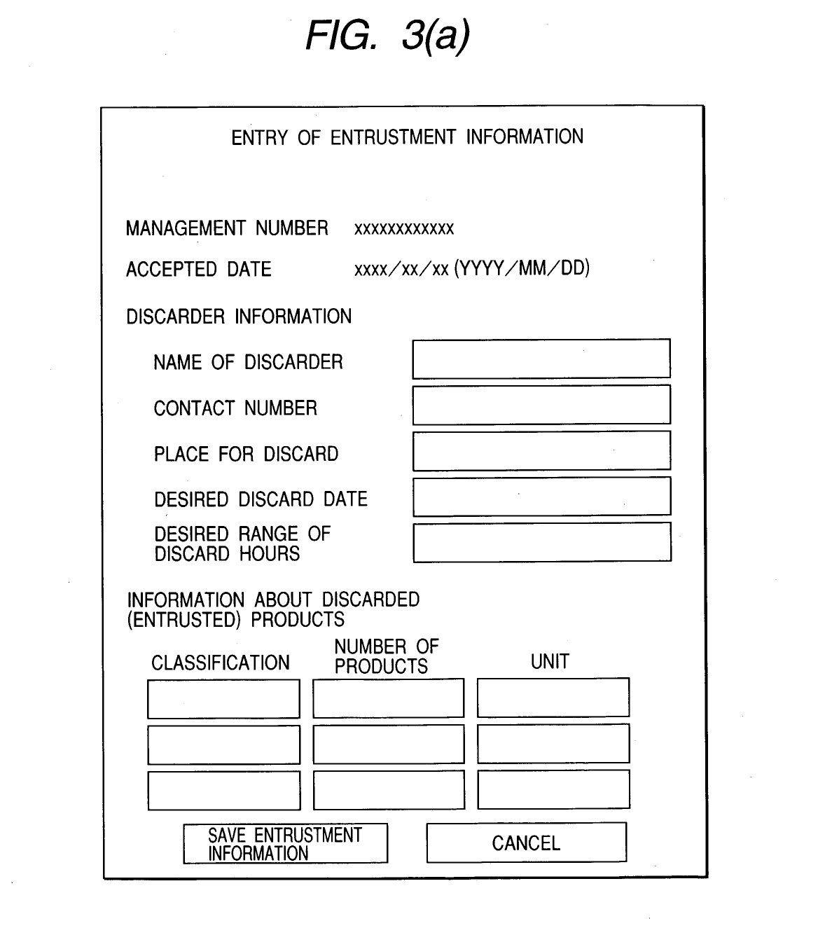

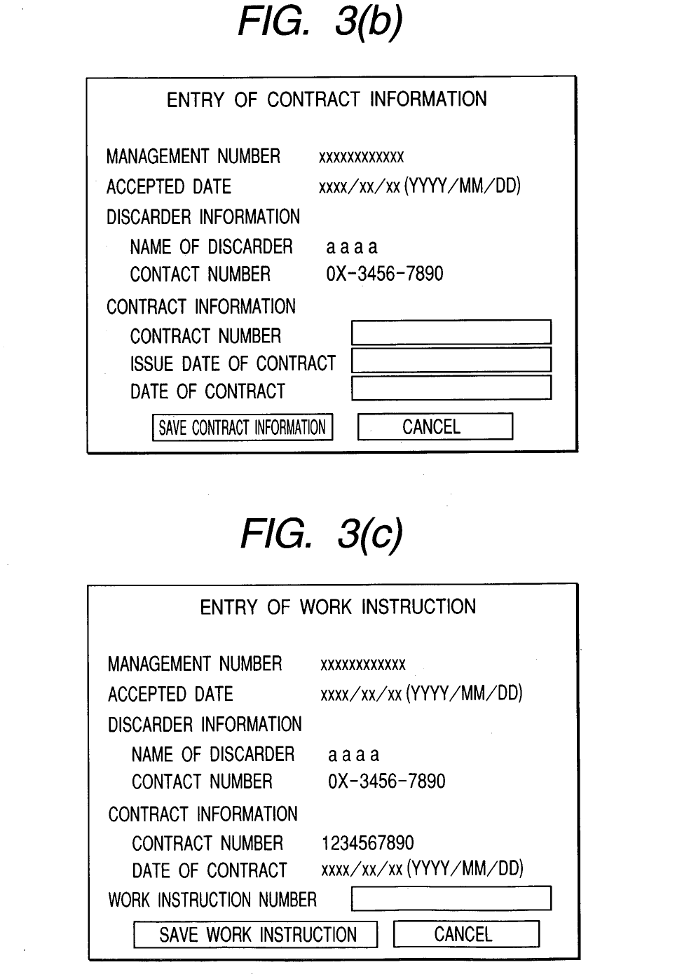

FIGS. 3(a) to 3(c) illustrate examples of data entry windows displayed on a screen, which are used by an entrusted company.

FIG. 3(a) illustrates a window for entry of entrustment. FIG. 3(b) illustrates a window for entry of contract. FIG. 3(c) illustrates a window for entry of long-term contract.

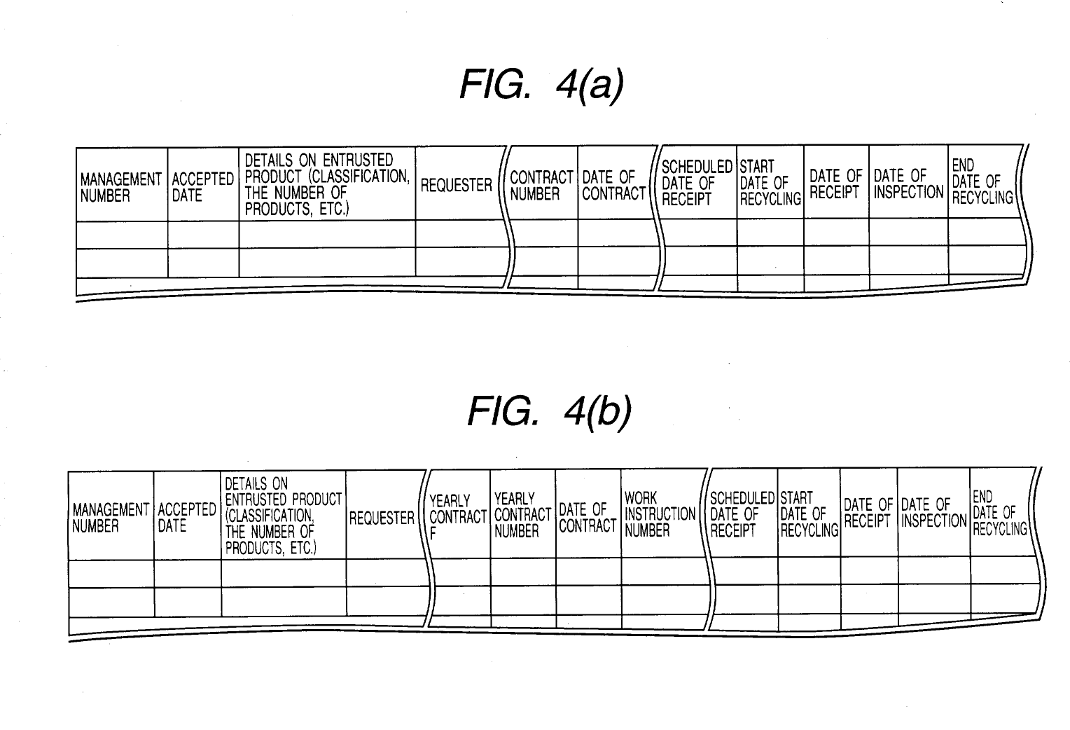

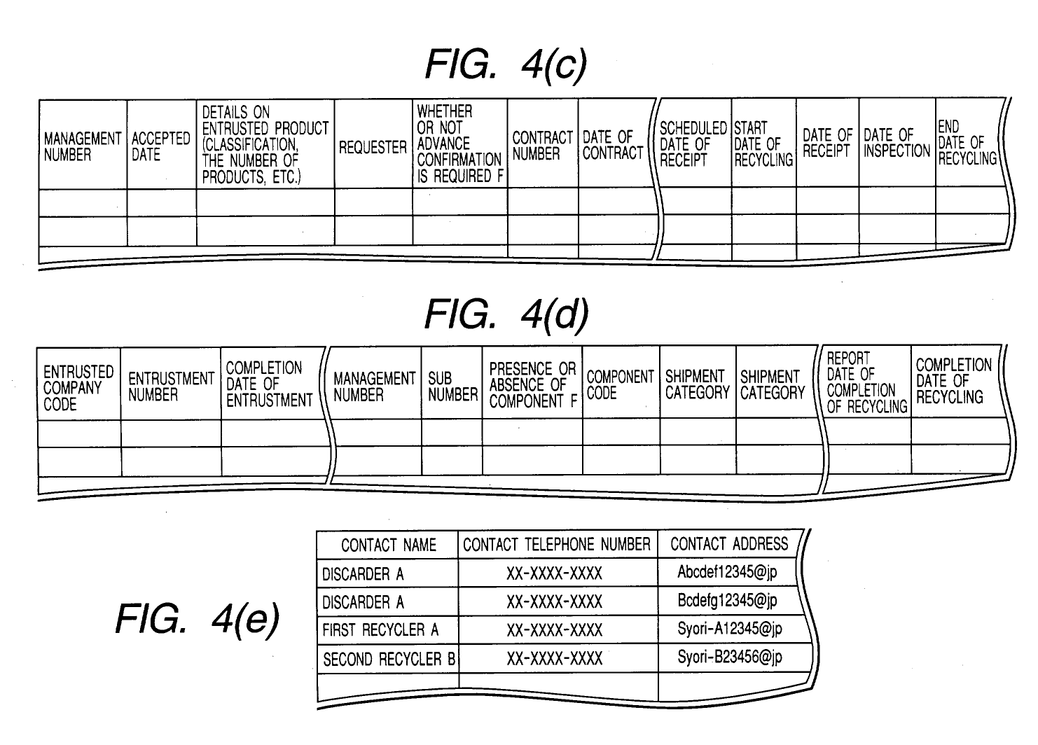

FIGS. 4(a) to 4(e) illustrate table formats of a database in the entrusted company according to one embodiment.

FIG. 4(a) illustrates a table format used for an individual contract. FIG. 4(b) illustrates a table format used for a long-term (yearly) contract. FIG. 4(c) illustrates a table format used when a contract is not required. FIG. 4(d) illustrates a table format used when a manufacturer associates a recycling acceptance number with a management number. FIG. 4(e) illustrates a database on discarders.

The entrusted company (i.e., the manufacturer or the first recycler, hereinafter referred to as entrusted company) inputs entrustment information using the window as show in FIG. 3(a). The entrustment information includes, for example, a management number, accepted date, a discarder name, a contact number of a discarder, a place for discard, desired discard date, a desired range of discard hours, and information about products to be discarded. The information about discarded products includes, for example, classification, the number of products, and unit. The entrustment information can be entered into a database used for management of recycling, which is shown in FIG. 4(a), by inputting required information using the windows in FIGS. 3(a) and 3(b).

Next, a contract made in advance for recycling and confirmation of the contract information in advance will be described.

In the first place, the advance contract will be described. After recycling is entrusted, an advance contract is sometimes required before the recycling is actually started. For example, if a discarder is an individual, a contract is not always required. However, if a discarder is a company, a contract is required. If a contract is required, a contract is made between the discarder and an entrusted company. Then, in the entrusted company, using the window as shown in FIG. 3(b), contract information including, for example, a contract number, the issue date of contract, the date on which a contract is made (for example, the date on which both parties affix seals to a contract to make the contract hold good) as well as a management number, the accepted date, and discarder information are inputted. As a result, data such as the management number, the accepted date, the entrustment information (classification, the number of products, etc.), the requester that is the discarder, the contract number, and the date of contract can be stored as a part of the data illustrated in FIG. 4(a). In order to treat the advance contract as an indispensable condition, it is so devised that if contract information is not stored and managed in the database, the recycling mentioned below cannot be started. In order to cause the recycling not to start, for example, if contract information is not stored and managed in the database, inhibiting a recycling request from being issued suffices. The control as described above ensures that the advance contract required for starting the recycling is made.

Next, the advance confirmation of a contract will be described. When the advance confirmation is actually performed, it may also be done in the following manner: a contract that holds good for a given period of time (for example, one year—hereinafter referred to as “yearly”) is confirmed in advance; and after that, at the time of each recycling, the recycling is performed by following simple procedures according to a work instruction, etc. on the basis of information about the advance confirmation. In this case, as shown in FIG. 4(b), a work instruction number of each recycling, and the like, as well as information such as a contract number of the yearly contract for recycling are recorded in the database used for management of recycling. This ensures that each recycling is managed on the basis of the advance confirmation of the contract. To be more specific, a flag used to judge whether or not each recycling job is based on a yearly contract is provided. If the recycling job is based on the yearly contract (if the flag is “Yes”), the recycling is not performed unless not only a contract number but also a work. instruction number is entered. FIG. 3(c) illustrates an example of an entry window used in the entrusted company in such a case. In addition to the contract number of the yearly contract, a work instruction number on a discard job basis is inputted on the entry window. This is a method that can handle recycling entrusted by a discarder that periodically discards products.

On the other hand, if advance confirmation is not necessary, as shown in FIG. 4(c), for example, a flag used to judge whether or not advance confirmation is required is provided. If a recycling job has a flag indicating that advance confirmation is not required, the recycling is started when entrustment information is entered even if advance contract is not entered. In this connection, FIG. 4(c) illustrates an example of the database, which is extended from the example shown in FIG. 4(a). In addition, it is also possible to extend the example shown in FIG. 4(b) in a similar manner.

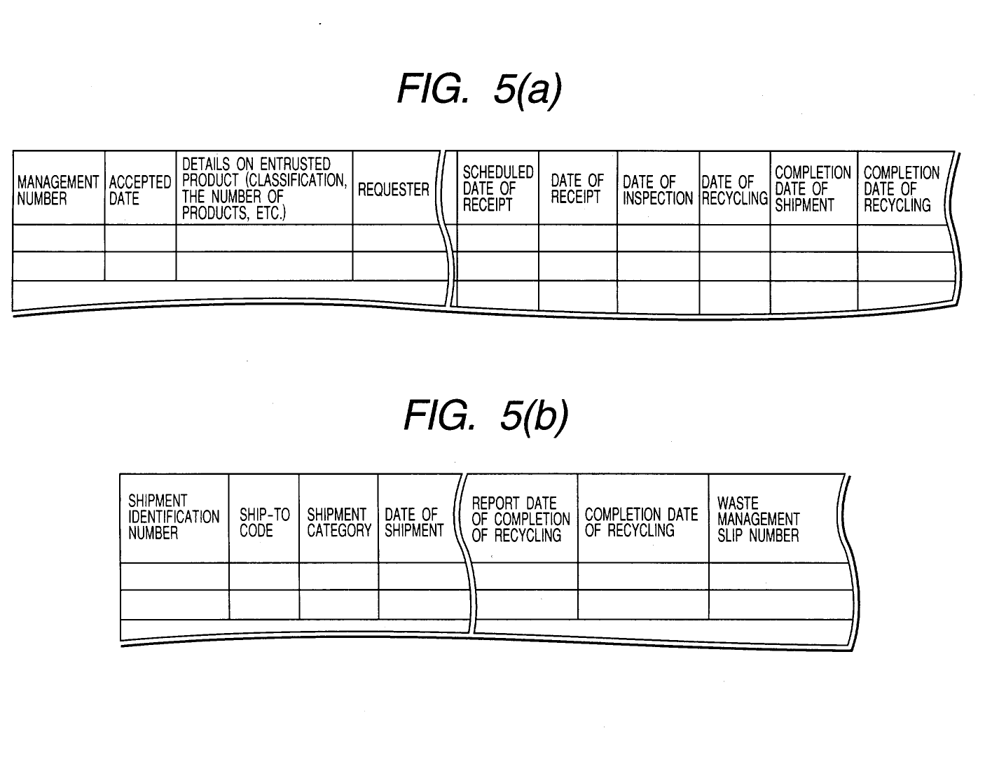

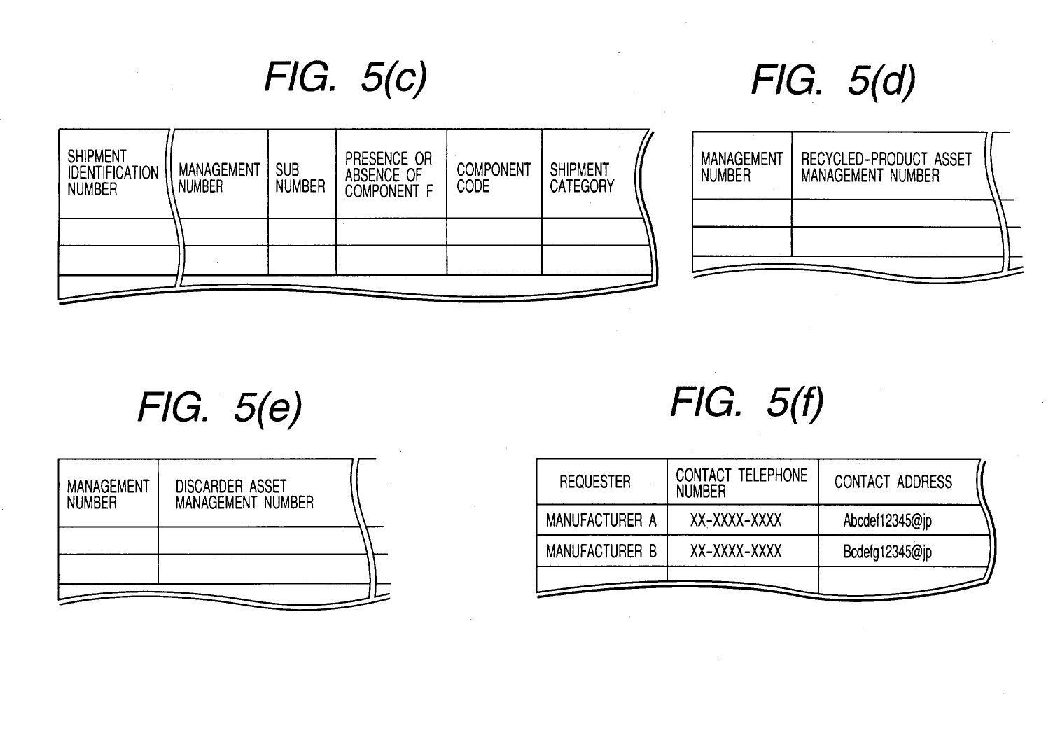

If a manufacturer is entrusted with the recycling, as soon as a contract and a work instruction are confirmed in advance, a recycling instruction is given to a department or a company that actually performs the recycling (both of them are called a first recycler). In this case, a management number which can identify an entrusted job is added to the recycling instruction so that the management number can be used in information management thereafter. The manufacturer associates the management number with the contract number or both of the contract number and the work instruction number. As showed in FIGS. 4(a) and 4(b), in this method, one management number is associated with a contract number or both of the contract number and a work instruction number in the database. Here, for example, a number into which the execution date and a job serial number are combined is assigned as a management number. If management numbers are assigned in this manner, only a look at a management number enables an easy judgment as to when this entrusted job should be completed, resulting in easy management of entrusted jobs. In addition, if a management number is automatically issued when the window shown in FIG. 3(a) is displayed, the convenience of work is also improved. Here, information such as details on entrusted products to be recycled (for example, classification of the entrusted product, the quantity of the entrusted products, etc.) corresponding to the management number is also sent to the first recycler. The first recycler enters the sent information about the entrustment into a database as shown in FIG. 5(a) to manage the information.

FIGS. 5(a) to 5(f) illustrates table formats of the database in the first recycler. FIG. 5(a) is illustrates entrustment information and the progress of work on the basis of a management number. FIG. 5(b) illustrates a database based on a shipment identification number. FIG. 5(c) illustrates a database used to associate the database in FIG. 5(a) with the database in FIG. 5(b).

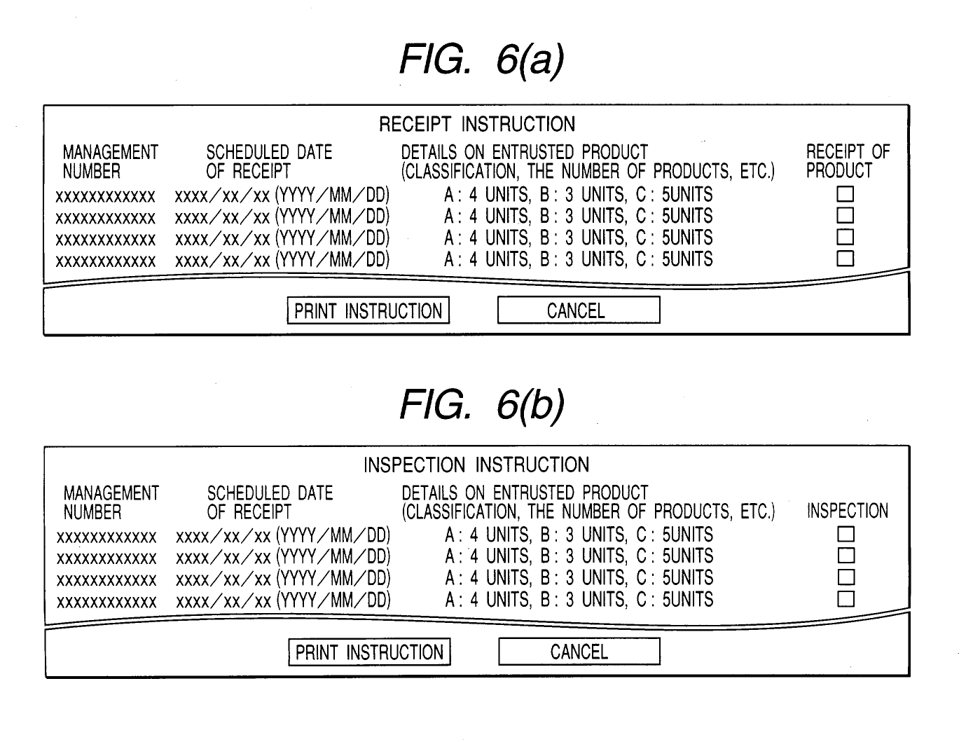

Next, receipt of products will be described with reference to FIGS. 6(a) and 6(b).

FIGS. 6(a) and 6(b) illustrate one embodiment of a work instruction of the first recycler.

FIG. 6(a) illustrates a receipt instruction. FIG. 6(b) illustrates an inspection instruction.

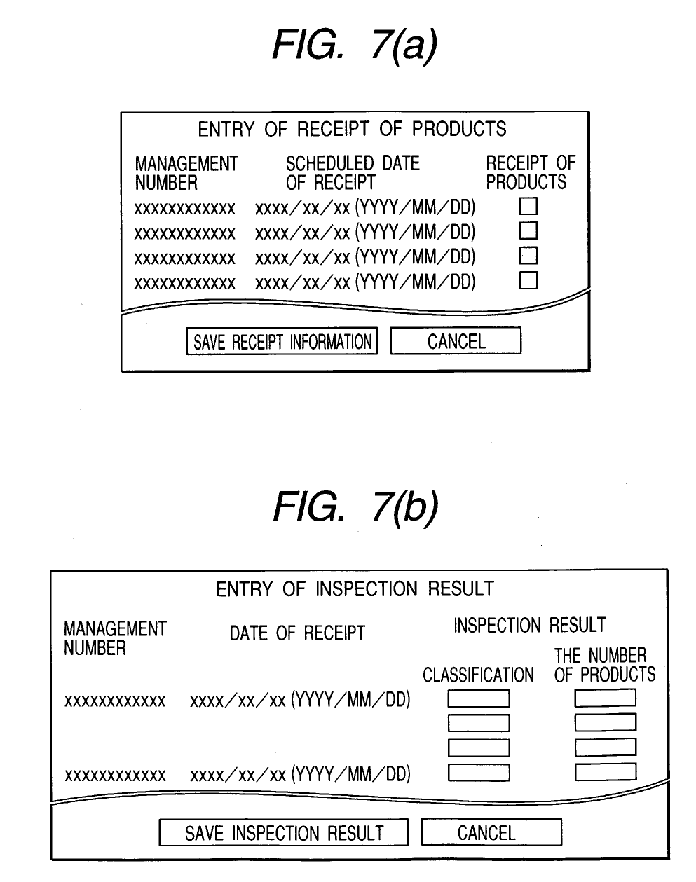

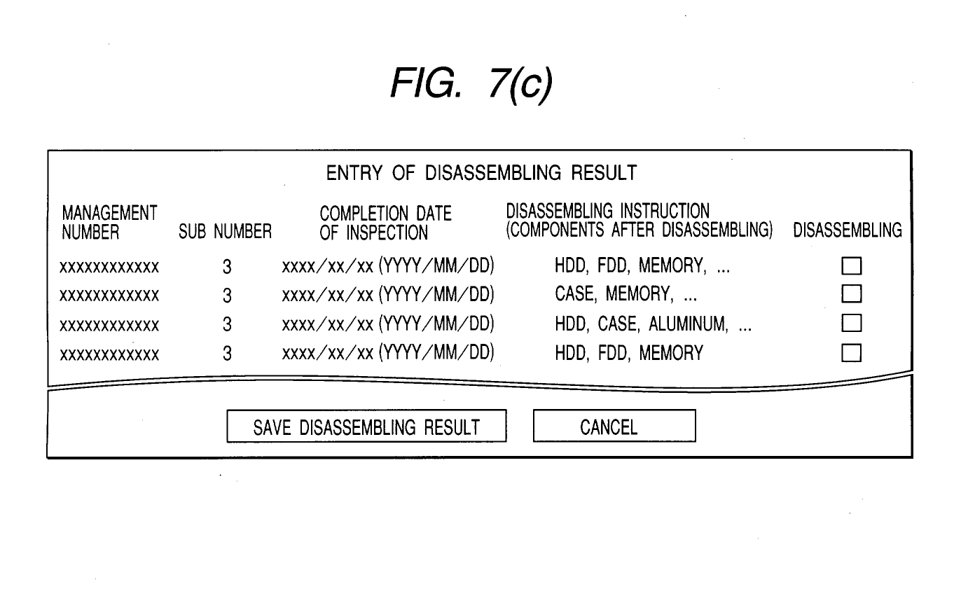

FIGS. 7(a) to 7(c) are diagrams illustrating an example of a window used by the first recycler.

FIG. 7(a) illustrates an entry window of receipt of products. FIG. 7(b) illustrates an entry window of inspection results. FIG. 7(c) illustrates an entry window of disassembling results.

The first recycler prints a receipt instruction as shown in FIG. 6(a) according to the entrustment information to receive products. The receipt work may also be instructed by inputting an instruction using a receipt instruction window instead of printing the receipt instruction. The point that entry of an instruction using a window can also be used to instruct work instead of printing the instruction is similarly applied to embodiments described below. To begin with, the first recycler system reads a management number described in a document attached to the products delivered from the discarder. A transport slip used for transportation of the products may also be used as the document for this purpose. Next, this management number is compared with the receipt instruction (FIG. 6(a)) to check whether or not the management number coincides with the entrustment information sent by the manufacturer beforehand. Otherwise, the following method may also be used: displaying a window as shown in FIG. 7(a); inputting a management number described in the document attached to the products arrived; and comparing the inputted management number with a management number stored in the database shown in FIG. 5(a) to check whether or not they coincide with each other. Other than the method in which an appropriate management number as shown in FIG. 7(a) is checked, the following methods can also be considered as a method for inputting a management number: a method in which a management number itself is inputted; a method in which a bar-code reader or the like reads a management number to input it into a system; and the like. In the case where the bar-code reader is used, it is also necessary to put a bar code on the documents attached to the products.

If the management numbers coincide with each other, the date of receipt is associated with the management number, and is then inputted into the database. In this connection, instead of the confirmation by the management number, for example, if a company number of a company that transports the products (hereinafter referred to as a transport number) is known from the management number and the discarder, associating the transport number with the management number before transmitting the transport number to the first recycler, and then managing the transport number on the first recycler side, enables confirmation in like manner even if the transport number is inputted as a substitute for the management number using the window shown in FIG. 7(a). The transport number may be included in the information that is sent from the manufacturer to the first recycler. In this case, a similar column is added to the database shown in FIGS. 4(a) and 5(a) to manage the transport number. In addition, judging from the date of reclamation included in the entrustment information, etc., if the time when the products arrive at the first recycler can be expected, adding columns of “scheduled date of receipt”, “scheduled time of receipt”, and the like, to the databases, and managing such information, assist receipt work. In FIG. 6(a), the entrustment information is also printed in the receipt instruction. However, this information is not always required for the receipt work.

It is to be noted that at the time of receipt check, checking only a management number of a product suffices. Whether or not the received products coincide with those described in the entrustment information may be checked after that. Accordingly, the receipt instruction shown in FIG. 6(a) does not always require the entrustment information to be described.

Next, goods inspection will be described. The details on the products, the receipt work of which has been completed, including classification and the number of products, are sorted according to management numbers (or according to transport numbers) to make an inspection instruction as shown in FIG. 6(b). Then, details on the products are inputted on a management number basis using a window as shown in FIG. 7(b). After that, this inputted information is compared with the entrustment information stored in the database shown in FIG. 5(a) to check whether or not they coincide with each other. As an goods inspection method, in addition to a method that uses an inspection instruction, the following methods can also be considered: a method that uses a window as shown in FIG. 7(b) where the details on the products are inputted for each management number of a product arrived and then the details on the products are compared; and a method in which information is obtained on an individual product basis and then the information is compared with the entrustment information. All the methods enable the same processing. Here, if the products arrived coincide with the details on the products, the date is inputted into a column “the date of inspection” in the database shown in FIG. 5(a) as completion of the inspection. Then, the recycling process after that is continued.

In this connection, confirmation work to check whether or not the details on the products coincide with the entrustment information is performed here as inspection work. The inspection work is similar to the inspection of the number of products that is usually performed in business transactions. However, if the recycling is entrusted on a weight basis for example, it is difficult to know the number of products. In such a case, using some algorithm can solve the problem. For example, if the result of the comparison falls within a given range, the result is regarded as coincidence.

In addition, in the inspection instruction shown in FIG. 6(b), entrustment information of a product is also displayed or output on a management number basis. The inspection work is performed on the basis of the entrustment information. Further, the following method is also conceivable: as is the case with the inventory work of assets, storing, in a system, information about products that actually exist instead of information about products that should exist; and comparing the information with the recycling acceptance information to check whether or not they coincide with each other. In this case, only management numbers of products to be inspected are displayed in the inspection instruction, whereas actual entrustment information (the number of products by classification) is not displayed or output.

Next, a method for checking entrustment information based on information on individual products will be described.

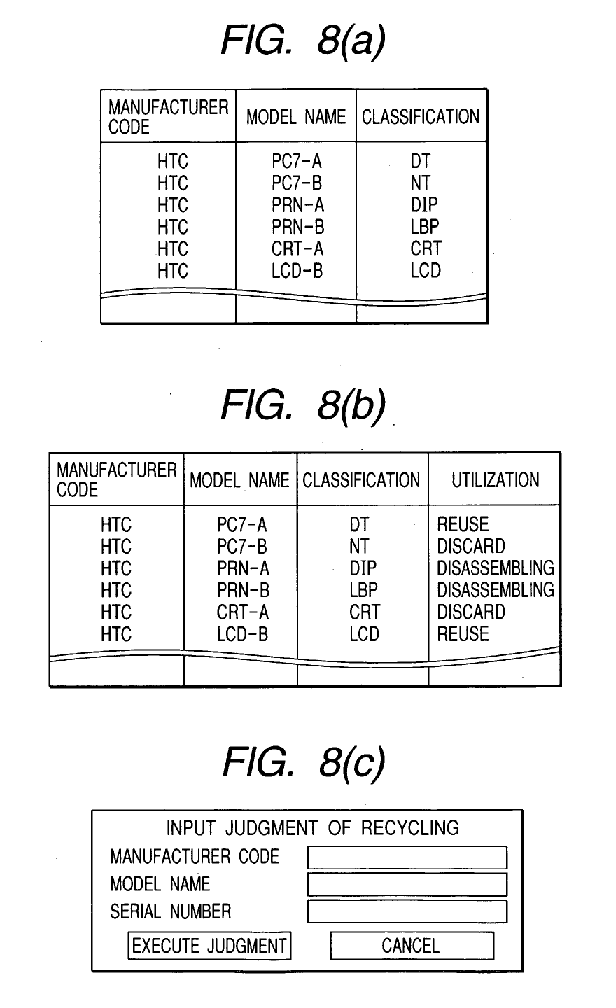

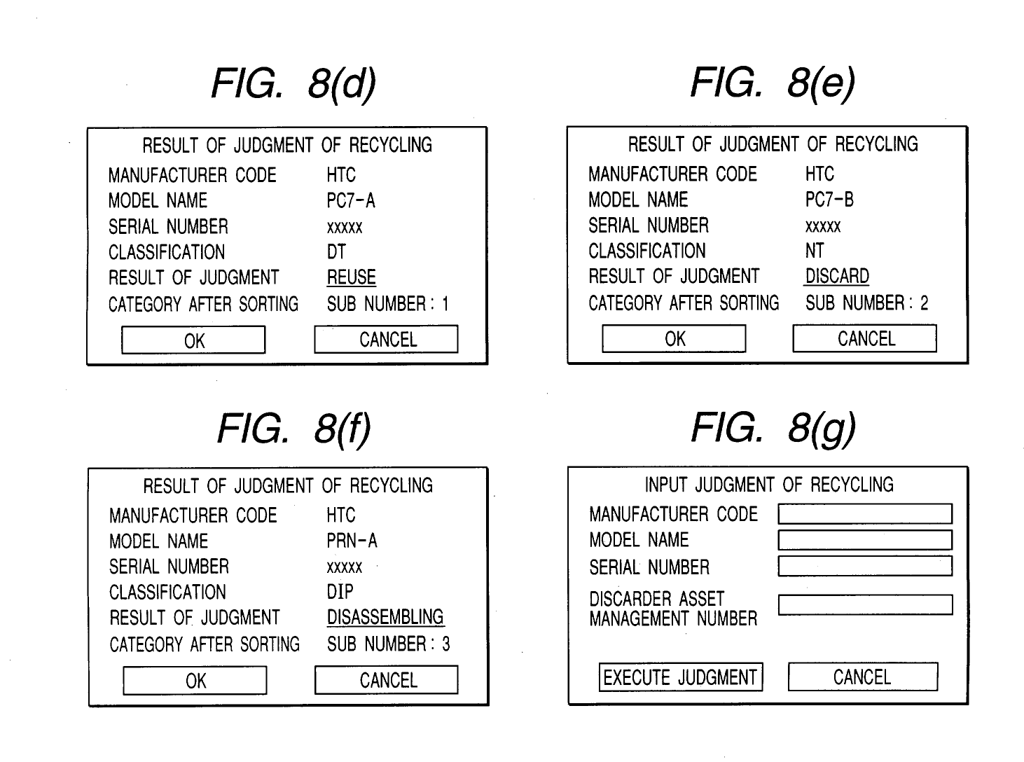

FIGS. 8(a) and 8(b) are tables illustrating databases used by the first recycler, in which information on individual products is stored.

FIG. 8(a) illustrates an example of a table format that includes a manufacturer code, a model, and classification as columns. FIG. 8(b) illustrates a table that is made by adding a column of utilization to the table in FIG. 8(a). FIGS. 8(c) and 8(g) are entry windows used for recycling judgment. FIGS. 8(d) through 8(f) are windows used for displaying the result of recycling judgment.

A method for confirming entrustment information by information about each individual product will be described in detail below. In most cases, a product is attached with information about each individual product (for example, manufacture name (manufacturer code), model name, a serial number, etc.). Therefore, this information is inputted into a system. Then, details on products are extracted from the information on individual products as shown in FIG. 8(a) using a database for conversion to compare the extracted details on products with the entrustment information. In this connection, it is desirable that a manufacturer provides the information shown in FIG. 8(a) beforehand. In general, the model name is usually determined under certain conditions. For this reason, when performing a search by use of a model name to extract information, algorithm of longest match, etc. is adopted instead of perfect match. This avoids the necessity for storing all model names of the same kind in a database, enabling efficient extraction by classification. The longest match algorithm that is usually used can be adopted without causing a problem.

Next, recycling will be described.

In a process of the recycling, for example, a judgment is made as to whether or not it is possible to handle the products arrived as reusable and valuable items on a classification basis or on a product basis. Here, utilizing a database for judging a product on an individual product basis as shown in FIG. 8(b) is effective. To begin with, information on individual products such as a manufacturer code, a model name, a serial number are inputted on an individual product basis using a window as shown in FIG. 8(c). Next, the database as shown in FIG. 8(b) is searched to extract information on individual products. Then, as shown in FIG. 8(d), 8(e), or 8(f), a window for displaying the result of judgment corresponding to the manufacturer code, the model name, and the serial number is displayed. With reference to the displayed result of judgment, it is possible to judge the recycling of each individual product. It is to be noted that the information shown in FIG. 8(b) is in general provided by the manufacturer beforehand. However, the fourth column “utilization” is set by the first recycler or another recycler (or another company, etc. other than the recycler) on a “manufacturer code” (second column) basis or on a “model name” (third column) basis. The information about utilization may also be stored in combination with the information provided by the manufacturer beforehand. In addition, FIG. 8(c) is also provided with an input column of a serial number as information on individual products. However, inputting into this column is not always required.

Taking the result of the recycling judgment into consideration, individual products are sorted out according to how to recycle the products so that the recycling of the products is properly managed. To achieve this sorting method, a sub number is added to each management number to manage the recycling of each product. For example, the following sub numbers are provided to manage the recycling: a sub number 1 is used for a product to be reused; a sub number 2 is used for a product to be mechanically recycled; a sub number 3 is used for a product to be disassembled; and a sub number 4 is used for a product whose the recycling will be entrusted. If there are many individual products, each of which is provided with a sub number, subdivided sub numbers may also be provided as follows: sub numbers 10, 11, 12, 13, . . . 19 are used for a product to be reused; sub numbers 20, 21, 22, 23, . . . 29 are used for a product to be mechanically recycled; sub numbers 30, 31, 32, 33, . . . 39 are used for a product to be disassembled; and sub numbers 40, 41, 42, 43, . . . 49 are used for a product whose recycling will be entrusted.

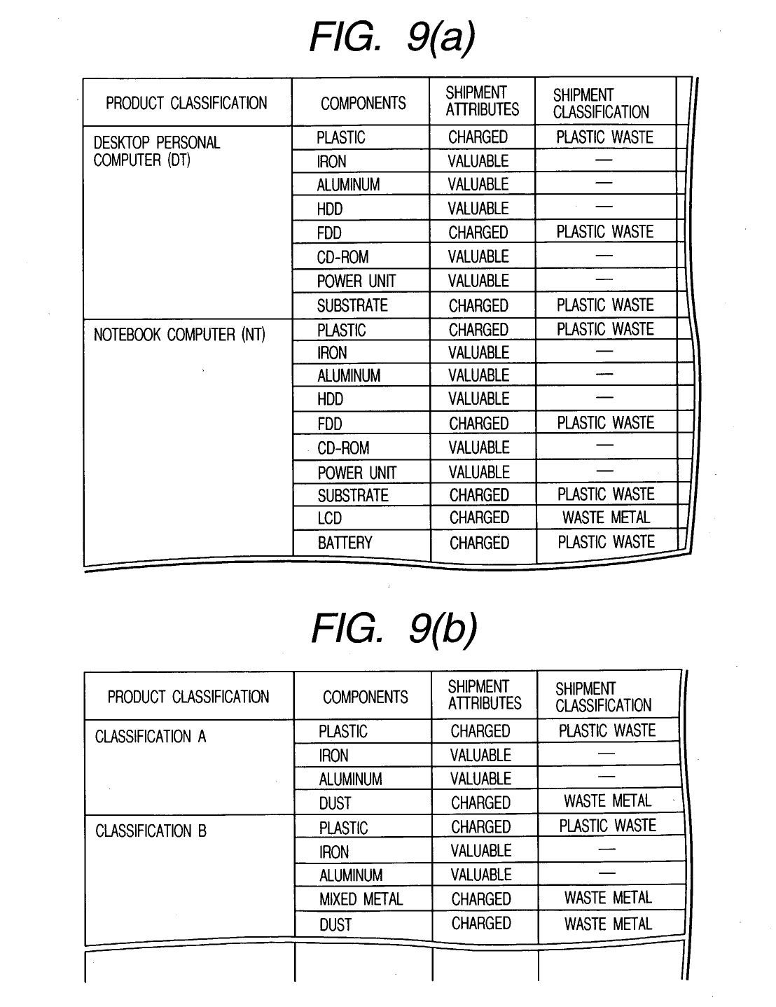

FIGS. 9(a) and 9(b) illustrate an example of a table format of a database on disassembling by the first recycler.

FIG. 9(a) illustrates an example of a database on disassembling whose product classifications relate to personal computers. FIG. 9(b) illustrates a database on disassembling in the case of product classifications A, B including a several kinds of metal.

A case where the first recycler disassembles the products shown in FIG. 9(a) will be described. As shown in FIG. 9(a) as an example, a desktop personal computer and a notebook computer have components such as plastic and iron, shipment attributes such as valuable and charged, and components such as plastic waste and waste metal. The components include two kinds: one is a component that will become a valuable item after disassembling; and another is a component whose discard will be charged after disassembling. The present law does not demand that valuable items are managed. Nevertheless, if it is also necessary to manage the valuable items, managing them in the same manner as the charged items suffices.

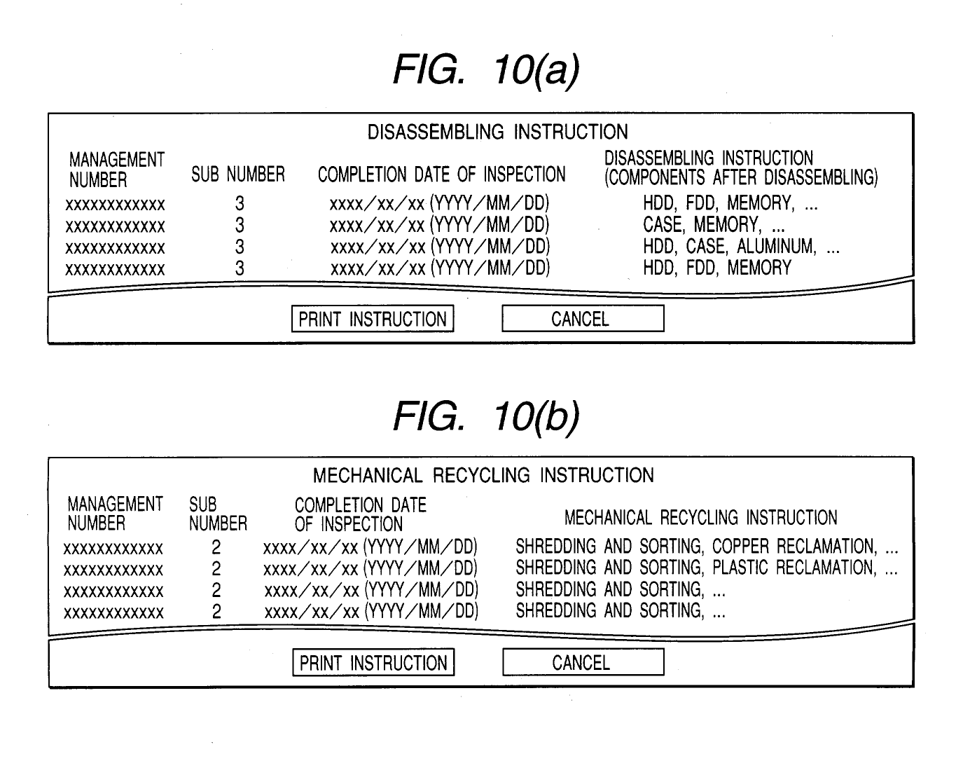

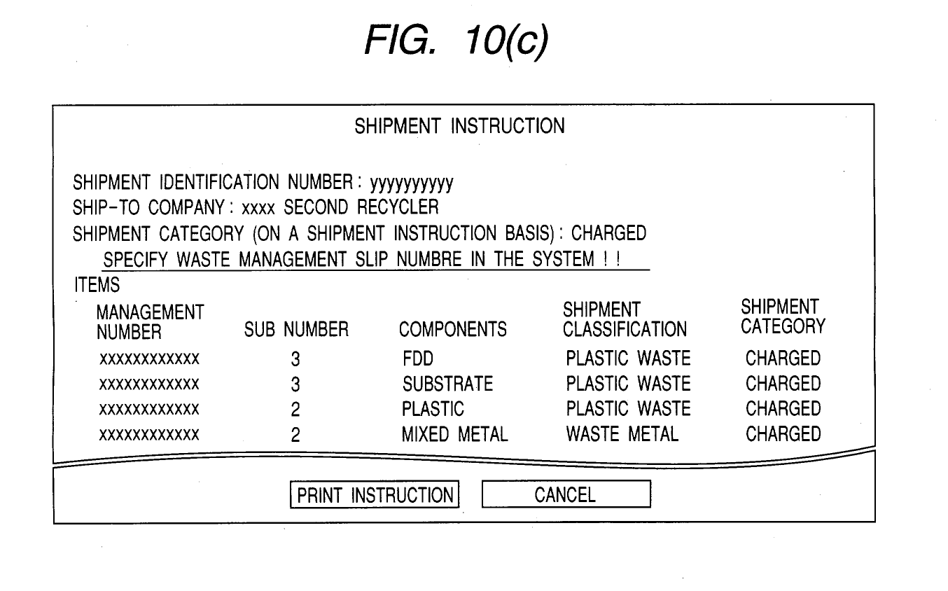

FIGS. 10(a) to 10(c) are diagrams illustrating one embodiment of a work instruction of the first recycler.

FIGS. 10(a), 10(b), 10(c) illustrate a disassembling instruction, a mechanical recycling instruction, and a shipment instruction, respectively.

Using a database on components on a product classification basis as shown in FIG. 9(a), a disassembling instruction (or a disassembling instruction window) as shown in FIG. 10(a) is made. Then, according to the disassembling instruction, a product is disassembled, and components after the disassembling are sorted out. Here, the result of the disassembling can be stored in the following manner: the result is stored on an individual product basis; the result is stored by a combination of a management number and a sub number; or the like. Even if the result of the disassembling is stored by a combination of a management number and a sub number, treating all individual products appropriate to the management number and the sub number as being disassembled enables the same management as that on an individual product basis. Therefore, the disassembling instruction shown in FIG. 10(a) describes a management number, a sub number, the completion date of inspection, a disassembling instruction (components after disassembling).

The result of the disassembling is entered using the window as shown in FIG. 7(c). The entry window of disassembling result displays, for example, a management number, a sub number, the completion date of inspection, a disassembling instruction, and a column to be checked when disassembling is completed. FIG. 7(c) illustrates an example of the case where the result of disassembling is entered on an individual product basis. A product that is disassembled is divided into components as shown in FIG. 9(a), which is how to treat the product. For example, taking personal computers as an example, a desktop personal computer can be divided into a hard disk drive (HDD), a flexible disk drive (FDD), a CD-ROM drive, a power supply unit, a substrate, etc. as well as plastic, iron, and aluminum, which constitute a case. In the case of a notebook computer, a liquid crystal display (LCD) and a battery are added to them.

In addition, if the recycling is performed by means of mechanical recycling that includes shredding and sorting, a mechanical recycling instruction as shown in FIG. 10(b) is made using the database on components after mechanical recycling on a product classification basis as shown in FIG. 9(b), and then the mechanical recycling is performed for an appropriate product according to the instruction. FIG. 10(b) illustrates, for example, a management number, the completion date of inspection, a mechanical recycling instruction that instructs shredding and sorting by machine, and reclaimed items.

A method for entering the result of mechanical recycling and the window therefor are similar to those of the disassembling described above. Accordingly, treating a product, which is mechanically recycled, as being divided into components as shown in FIG. 9(b) suffices. In the case of the mechanical recycling, components including materials (such as plastic and iron), shredder dust, and other mixtures may exist. Nevertheless, a basic way of thinking is similar to that of the disassembling.

Next, the first recycler does shipment work in the following manners: a product to be reused is shipped as it is; a product to be disassembled is shipped as components after the disassembling; a product that has been mechanically recycled is shipped as components after the mechanical recycling; and a product that has not been mechanically recycled is shipped as it is. Here, the reusable product and a component whose a shipment attribute is “valuable” in the database as shown in FIGS. 9(a) and 9(b) are shipped to a buyer or the like. The product that has not been mechanically recycled and a product whose shipment attribute is “charged” are shipped to the second recycler, which is entrusted with the recycling. In particular, the product shipped to the second recycler that is entrusted with recycling requires appropriate management.

The first recycler makes a shipment instruction (or displays a shipment instruction window) as shown in FIG. 10(c) to do shipment work for an appropriate product. The shipment instruction whose information is to be entered includes a shipment identification number, a ship-to company (if shipment is made to a second recycler), a shipment category, target management numbers, sub numbers, components such as a FDD and a substrate, shipment classifications such as plastic waste and waste metal, and shipment attributes indicating that the recycling is charged. The reusable product and the product that has not been mechanically recycled are shipped using a management number and a sub number. The disassembled product and the mechanical recycled product are shipped by a combination of a management number, a sub number, and a component. Further, a shipment state is managed by assigning an identification number such as a shipment number and a recycling entrustment number on a shipment basis. It is to be noted that one shipment may also include a plurality of management numbers and sub numbers as a set, or a management number, a sub number, and a component as a set, and that even mixing them does not cause a problem. However, since a management level of a shipment whose shipment attribute is “valuable” is different from that of a shipment whose shipment attribute is “charged”, it is not desirable that both of them are mixed. However, if they are mixed, it is possible to cope with the problem by managing both of the shipments as a shipment having a shipment attribute “charged” whose management level is high.

Next, entry of shipment and entry of recycling result of shipped product will be described.

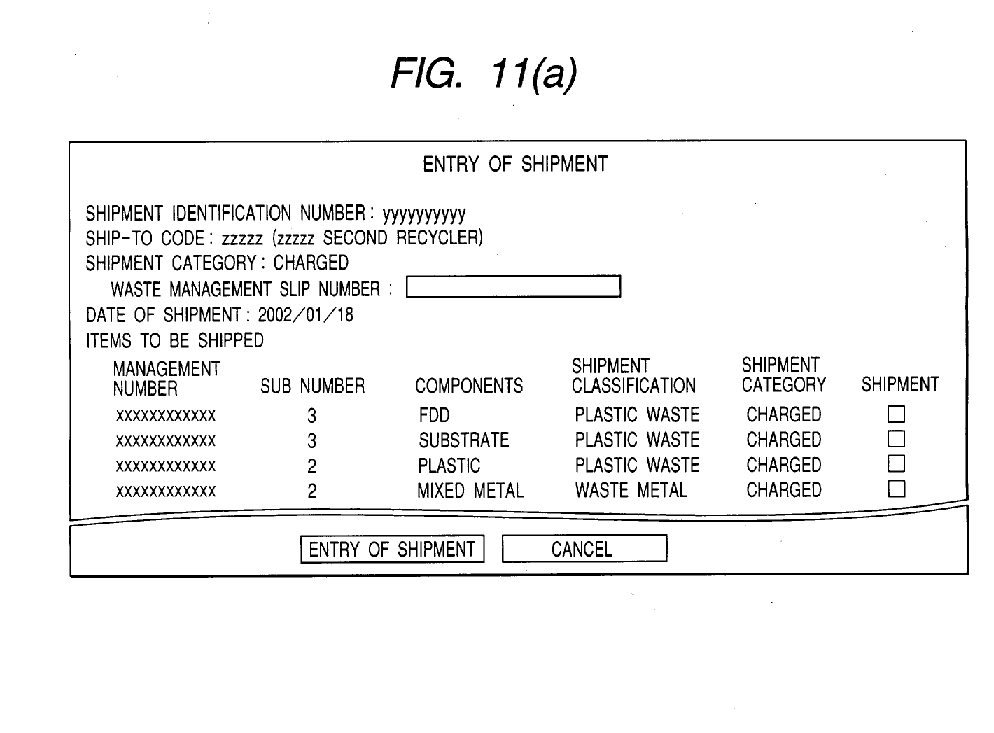

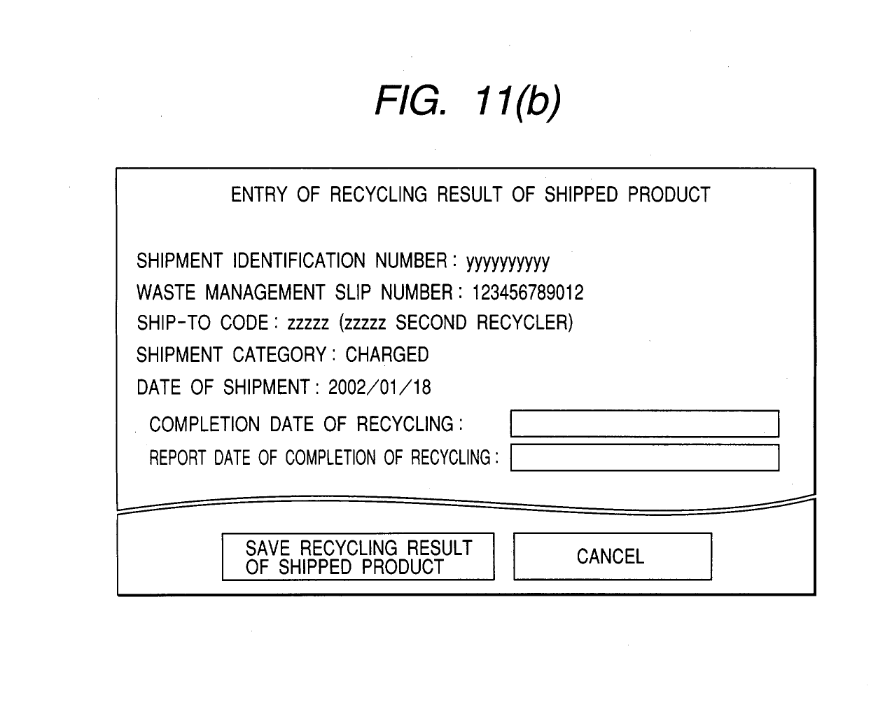

FIGS. 11(a) and 11(b) illustrate one embodiment of an entry window of shipment used by the first recycler. FIGS. 11(a) and 11(b) are windows used for the entry of shipment and the entry of recycling result of shipped product respectively.

The result of the shipment is entered using the window as shown in FIG. 11(a). The window as shown in FIG. 11(a) is made by adding a waste management slip number and the date of shipment to the window shown in FIG. 10(c). In addition to it, each item to be shipped is provided with a column in which a check mark is put when the shipment is completed. Entering the result of the shipment into the shipment management database as shown in FIGS. 5(b) and 5(c) enables management of shipment numbers and shipped items associated with the numbers (each shipped item is identified by a management number and a sub number, or by a management number, a sub number, and a component). In this case, the shipment management database also manages a shipment attribute of each shipped item, that is, “valuable” or “charged”. In the case of “charged”, the shipped item requires proper management. It is to be noted that if a shipment attribute is “charged”, it is necessary to manage the shipped item properly. For this reason, in order to manage shipped items on a component basis, a slip for managing a shipment classification representing a classification of a component is made. The recycling after that is managed by a slip number. If one shipment has a plurality of shipment classifications, a plurality of slips are issued and managed, which is one of management methods. Otherwise, as another method, each shipment is allowed to have only one shipment classification. Therefore, a single slip is issued for one shipment, and the shipment is managed by the slip thereafter.

Whether or not the second recycler has recycled a product properly is managed by an identification number of each shipment. Accordingly, in particular, as regards an item whose shipment attribute is “charged”, recycling report information obtained from the second recycler to which the recycling is entrusted is stored in the shipment management database as shown in FIG. 5(b). More specifically, the recycling report information on the entrusted product, that is to say, the completion date of recycling and the report date of completion of recycling, is inputted using the window as shown in FIG. 11(b), and then the information is stored in the database as shown in FIG. 5(b). In this connection, in the example shown in FIGS. 11(b) and 5(b), only a piece of data is inputted and stored as the result of recycling. However, as the need arises, even if there are a plurality of results, only adding columns to the database and the window makes similar handling possible.

Moreover, the first recycler uses the report from the second recycler to associate the identification number with the management number, and thereby keeps track of the progress of the recycling on a management number basis (that is, on an entrustment basis). Further, as regards the disassembled product and the mechanically recycled product, the first recycler keeps track of recycling result information from the second recycler on a recycled component basis. The recycling result information on a component basis is finally associated with a management number to keep track of the progress of the recycling on a management information basis, and is then stored in the database shown FIG. 5(a). After that, the recycling result information is reported to the manufacturer that entrusted the recycling. As a result, the first recycler can manage the progress of the product recycling which was entrusted by the manufacturer from two aspects together: one aspect is the recycling in its own company; and another aspect is the recycling in the second recycler. A method for associating a management number will be described later.

The manufacturer receives a report on the progress of the recycling from the first recycler on a management number basis. Then, the report on the progress of the recycling on a management number basis is stored in the database as shown in FIG. 4(a) to keep track of the progress of the recycling the discarder entrusted. After that, using a management number and a contract number in the database as shown in FIGS. 4(a) and 4(b), the progress of the recycling is reported to the discarder on a contract basis. Otherwise, using a combination of a contract number and a work instruction number, the progress of the recycling may also be reported on a work instruction basis. In this case, a contract number and a work instruction number identify the work instruction. This enables the manufacturer to keep track of the recycling, which was entrusted by the discarder, including the progress of the recycling by the first recycler, the second recycler, (the third recycler, or more).

Moreover, to ensure that the recycling is completed within a given period of time after the recycling is started, an attention message or a warning about the delay in recycling is given on a predetermined day before the time limit on a management number basis. Sending attention and warning information to companies involved in the recycling as the need arises, and notifying them of the progress of the recycling accordingly, permit an administrator of the recycling and the companies involved to know how the recycling is delayed. As a result, appropriate measures against the delay, for example, changing a work plan of the first recycler, and sending a request to the second recycler, become possible. How to actually take such measures will be described later.

In this example, advance confirmations of the recycling and the transportation are sometimes required between the manufacturer and the first recycler, between the first recycler and the second recycler, and between transportation companies, each of which takes charge of the transportation between the manufacturer and the first recycler or between the first recycler and the second recycler. Examples of a method for ensuring the advance confirmation include a method in which an entrusted company is managed by use of a contract number and a method in which only a company for which advance confirmation is performed beforehand is entrusted with the recycling.

Next, a process flow of the first embodiment will be described with reference to FIG. 2.

In step 200, a discarder requests a manufacturer for recycling. If the discarder is not an individual, for example, if the discarder is a company, the discarder and the manufacturer are required to make an individual contract or a contract with fixed term between them. Accordingly, in step 201, a contract is made, and a contract number is assigned. In step 202, the manufacturer assigns a management number to the requested recycling, and then associates the management number with the contract number. In step 203, the manufacturer assigns the management number to entrustment information, and thereby instructs the first recycler to perform the recycling. In step 204, the manufacturer adds the management number information to a product, and then sends the product to the first recycler. In step 205, upon receiving a product, the first recycler inputs the management number. In step 206, the first recycler informs the manufacturer of receipt information (management number). In step 207, the first recycler inspects the product, and then inputs the management number and details on products. In step 208, the first recycler informs the manufacturer of inspection information. In step 209, the first recycler judges how to recycle the product, for example, reuse, disassembling, or discard, etc. In step 210, the first recycler assigns a sub number according to how to recycle the product to be recycled, and then associates the product with the management number and the sub number. In step 211, the first recycler recycles the product by reusing, disassembling, or discarding the product. In step 212, the first recycler ships the recycled items to the second recycler. When shipping the items, the first recycler assigns an identification number such as a recycling entrustment number in step 213, and entrusts the second recycler with second recycling in step 214. Here, the reusable product and the product that has not been mechanically recycled are shipped by a combination of a management number and a sub number. The disassembled product and the mechanical recycled product are shipped by a combination of a management number, a sub number, and a component. Further, a shipment state is managed by assigning an identification number such as a shipment number and a recycling entrustment number on a shipment basis. In step 215, upon completion of the recycling, the second recycler reports by a recycling acceptance number. In step 216, the first recycler associates the recycling acceptance number with the management number. In step 217, the first recycler reports on the recycling of the product, which has been completed, to the manufacturer by use of its management number. In step 218, the manufacturer associates the management number with the contract number. In step 219, the manufacturer reports on the recycling to the discarder by use of the contract number.

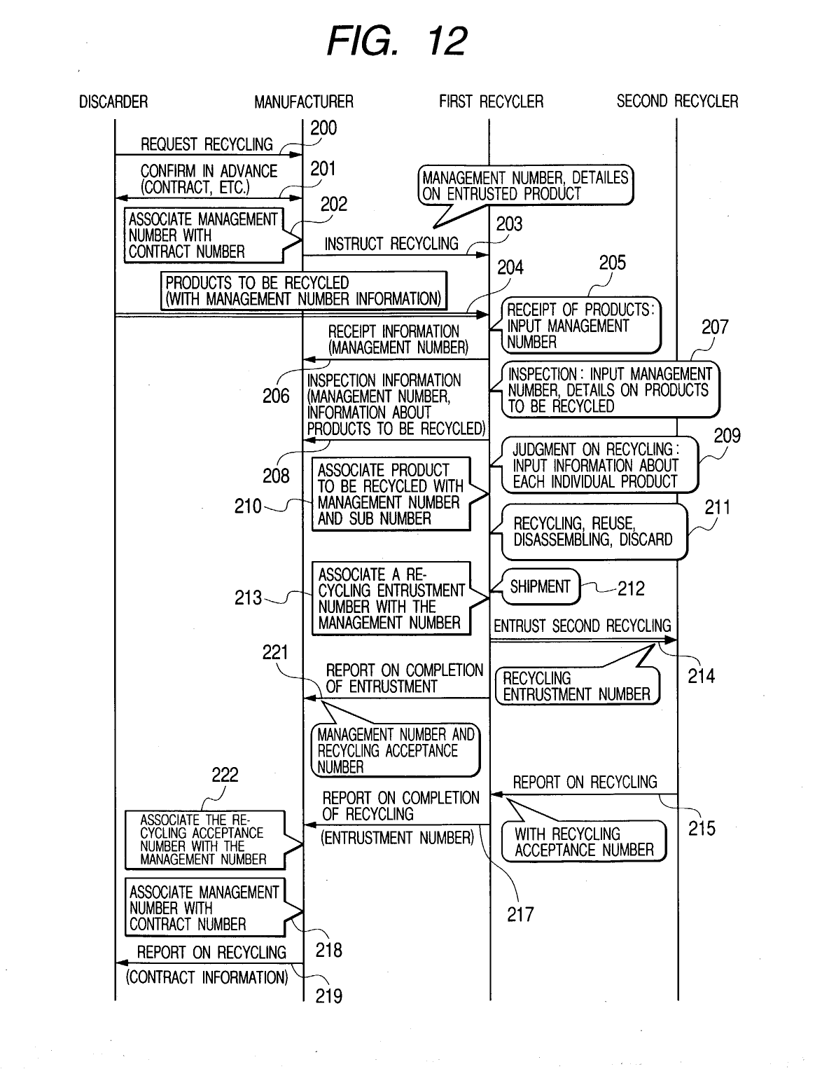

Next, a process flow of a second embodiment will be described with reference to FIG. 12. The second embodiment relates to a case where a manufacturer associates the result of recycling entrustment on the first recycler side with the entrusted recycling on the manufacturer side.

FIG. 12 is a flowchart illustrating processing of the recycling management system according to the second embodiment of the present invention.

In FIG. 12, the same steps as in FIG. 2 are designated by like reference numerals; therefore, the description thereof will be omitted.

A process flow until a first recycler ships a product and a component as described in steps 200 to 214 is the same as that in the embodiment described above. Upon finishing the shipment to the second recycler, the first recycler reports on the completion of the recycling entrustment to a manufacturer. The report on the completion of the recycling entrustment includes the following information: the recycling entrustment number, and also the management number and the sub number that are included in the recycling entrustment; or the recycling entrustment number, and also the management number, the sub number, and the component that are included in the recycling entrustment. The manufacturer stores the information in the database as shown in FIG. 4(d).

The second recycler reports on the recycling, which has been entrusted to the second recycler, to the first recycler together with the recycling entrustment number. The first recycler provides the manufacturer with the report on the recycling received from the second recycler as a report on the completion of the recycling. The manufacturer stores the report on the completion of the recycling in the database as shown in FIG. 4(d), and associates the report with the management number. As a result, the manufacturer can keep track of the progress of the recycling which was entrusted to the first recycler on a management number basis.

With reference to FIG. 12, in step 214, the first recycler entrusts the recycling to the second recycler. After that, in step 221, the first recycler associates a recycling number with the recycling acceptance number, and then reports on the completion of the recycling entrustment to the manufacturer. If the report is given in this manner, when the completion of the recycling is reported in step 217, the manufacturer can associates the recycling acceptance number with the management number in step 222. This method will be detailed later.

According to the second embodiment, the manufacturer can properly keep track of the progress of the recycling of the entrusted product. In addition, the first recycler and the second recycler have only to keep track of the progress of the recycling in each company and to report the progress. This facilitates office work in the recyclers. As a result, expenses on the recycling entrustment can be reduced.

Next, a third embodiment will be described below.

The third embodiment relates to a case where a discarder requests a first recycler for recycling instead of requesting a manufacturer.

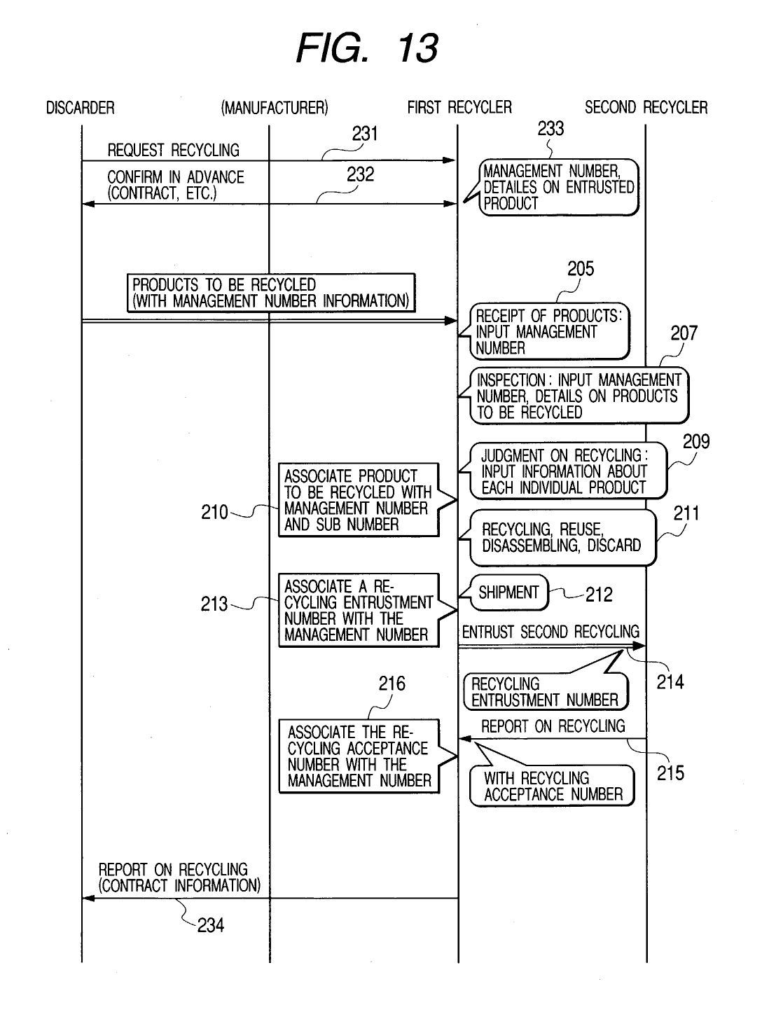

FIG. 13 is a flowchart illustrating processing of the third embodiment.

In FIG. 13, the same steps as FIG. 2 are designated by like reference numerals; therefore, the description thereof will be omitted.

The discarder entrusts the recycling to the first recycler. In this case, the recycling contract shown in FIG. 2 is made between the discarder and the first recyclers. At this time, a management number and information on products to be recycled is also sent. The management number is a contract number, or a combination of a contract number and a work instruction number. The process after that is similar to the case shown in FIG. 2 except that the last report on the recycling is directly sent from the first recycler to the discarder. It is to be noted that although the first recycler associates the management number with the contract number in the third embodiment, the discarder may also associate them with each other. In addition, if the recycling is performed on the basis of a yearly contract, a management number may also be associated with a combination of a contract number and a work instruction number to perform the recycling.

With reference to FIG. 13, in step 231, the discarder directly requests the first recycler for recycling. In step 232, the discarder confirms a contract in advance, and if no contract is made, the discarder makes a contract with the first recycler. In step 233, the first recycler informs the discarder of a management number, and details on entrusted product. Upon receipt of a report on the recycling from the second recycler in step 215, the first recycler associates a recycling acceptance number with the management number in step 216, and then sends a report on the recycling together with contract information in step 234.

According to this method, when the recycler receives a request from the discarder to perform recycling, the recycler can check whether or not the entrusted products are correct, and whether or not the entrusted products have arrived properly. Accordingly, it is possible to prevent the recycling from being performed incorrectly, and it is also possible to prevent a product that is not entrusted from being recycled. Further, a problem of a recycling charge that needs man-hours for its collection can be avoided.

In the undermentioned embodiment, a case where the manufacturer is entrusted with recycling will be described as an example. However, this can also be applied to the case where the first recycler is directly entrusted with the recycling as described in the first embodiment.

When the product arrives from the discarder in the process flow shown in FIGS. 2, 12 and 13, the first recycler reads a management number attached to the product, and then compares the management number with a management number that has been sent beforehand. If they coincide with each other, the process proceeds to the subsequent process. However, if they do not coincide with each other, to be more specific, if a product having an unscheduled management number arrives, a warning is issued to stop recycling for the unscheduled product, which is a required function.

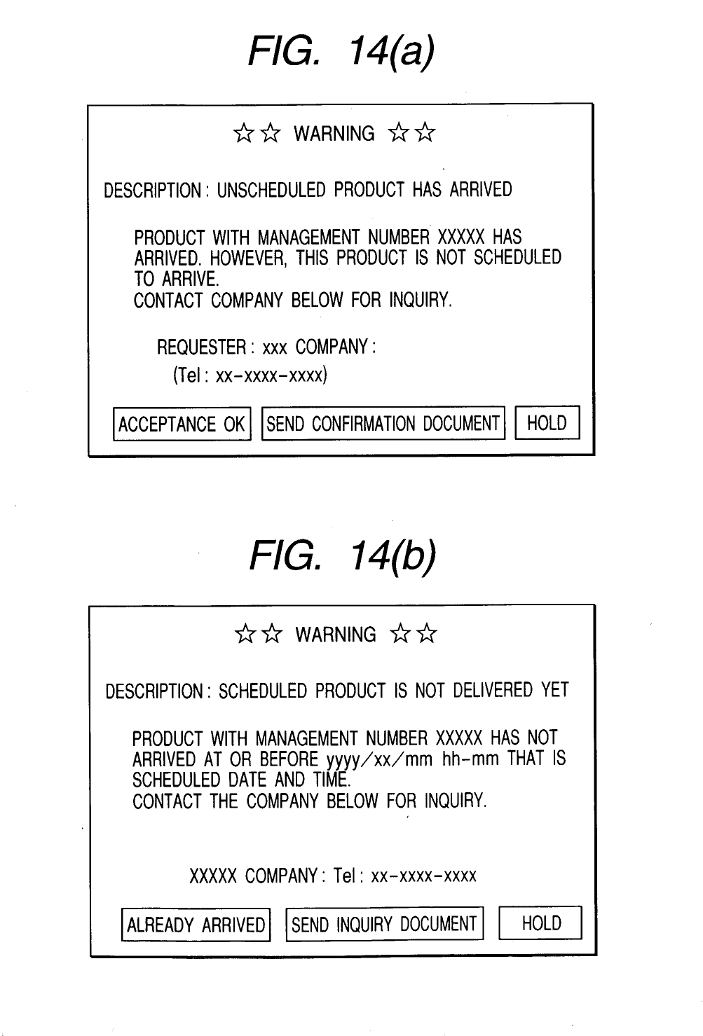

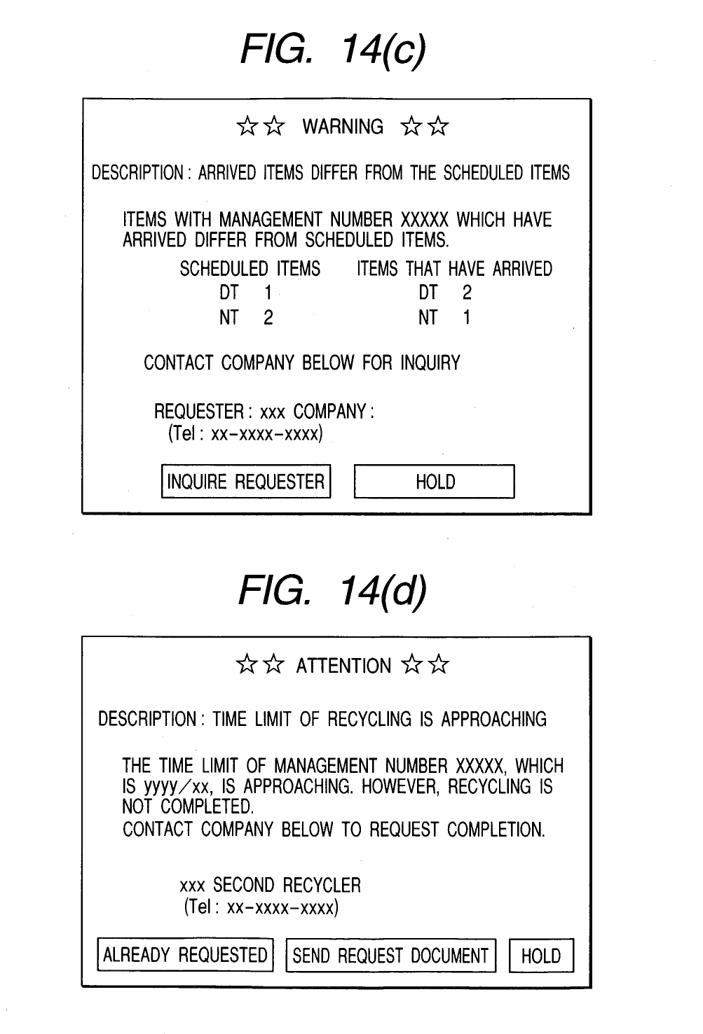

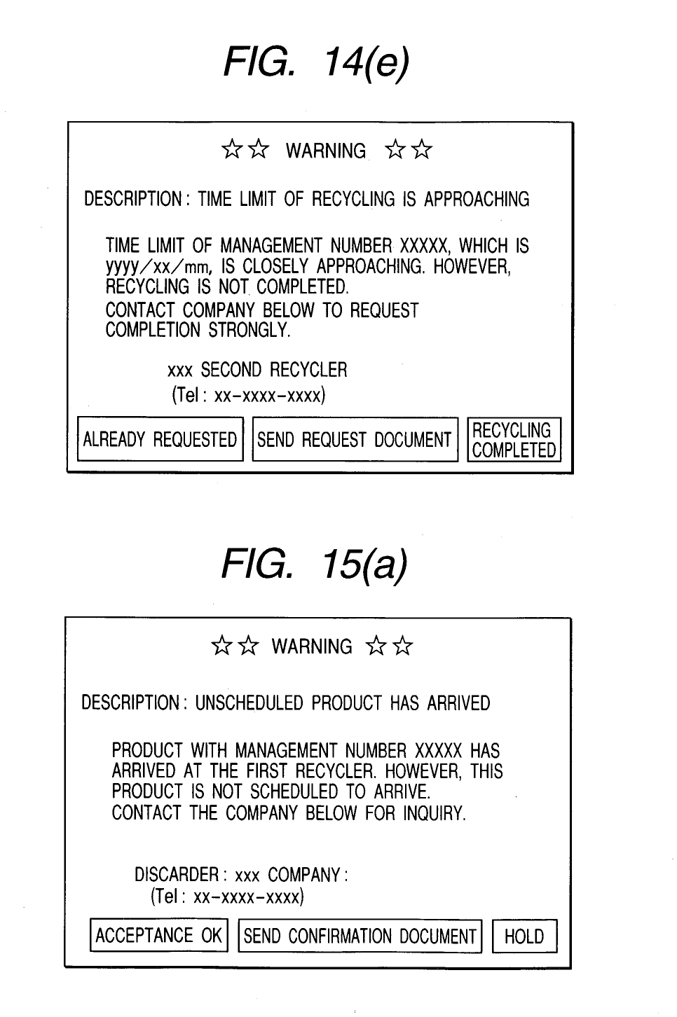

FIG. 14 illustrates examples of windows used for the first recycler. FIG. 14(a) is a warning window displayed when an unscheduled product has arrived. FIG. 14(b) is a warning window displayed when a scheduled product is not delivered yet. FIG. 14(c) is a warning window displayed when arrived items differ from the items that have been informed beforehand. FIG. 14(d) is an attention window displayed when time limit of recycling of a product is approaching. FIG. 14(e) is a warning window displayed when time limit of recycling of a product is approaching.

Whether or not a management number attached to a product coincides with a management number informed beforehand is checked. If it is judged that they do not coincide with each other, the product is regarded as an unscheduled product. Then, as shown in FIG. 14(a), a warning window indicating that an unscheduled product has arrived is displayed on the display unit 22, or the like, to stop the first recycler proceeding to the next step. A method for actually stopping the first recycler proceeding to the next step is that an instruction to proceed to the next step for a product whose a management number does not coincide with the informed management number is allowed to be displayed or outputted. An operator or an administrator of the first recycler who recognizes the warning to the effect that an unscheduled product has arrived can determine how to take measures against the discrepancy by inquiring of the manufacturer and the discarder about the discrepancy.

It is to be noted that as shown in FIG. 14(a), if a contact information management database as shown in FIG. 5(f) is prepared, and if contact information of the manufacturer that entrusted the recycling is displayed on the warning window, efficiency in work can be improved. In addition, providing a function of sending a confirmation document to a contact address enables an easier inquiry about the warned product. The first recycler inquires of the manufacturer about the management number, and inputs it in the warning window. The inputted management number is treated as a management number that is stored in the database beforehand. If details on the product as well as the management number can be entered, the next work can be done more smoothly. As a matter of course, the details on the product may also be separately entered. In such a case, if an option of a temporary hold of the work is provided, the operator and the administrator of the first recycler can do the work easily.

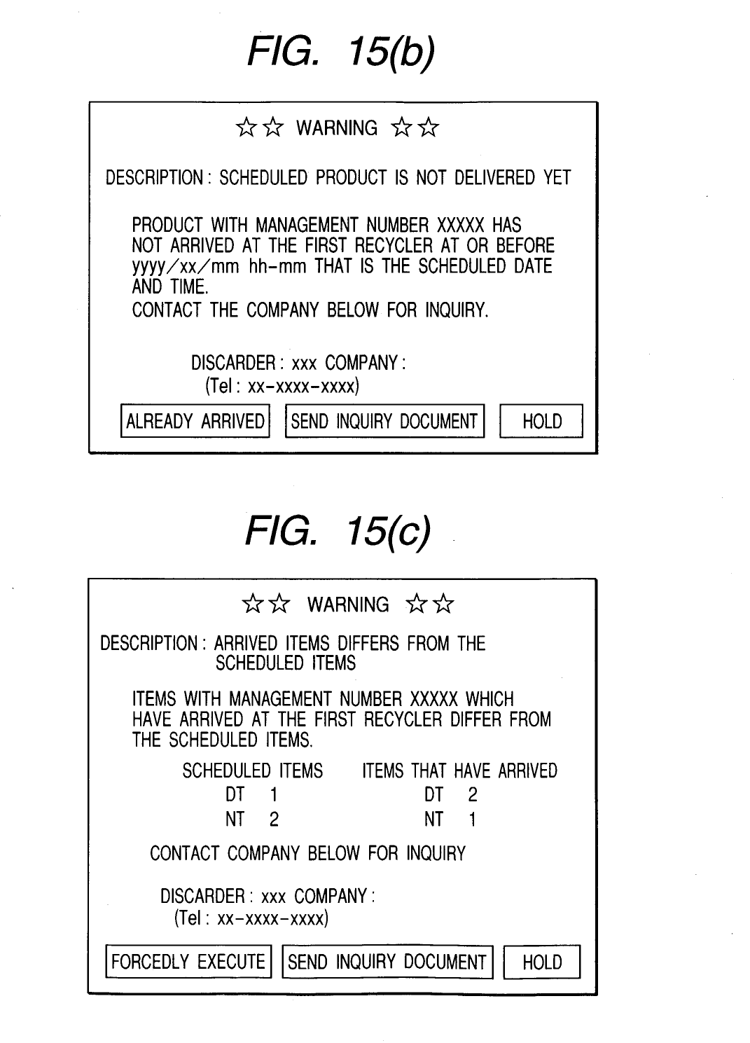

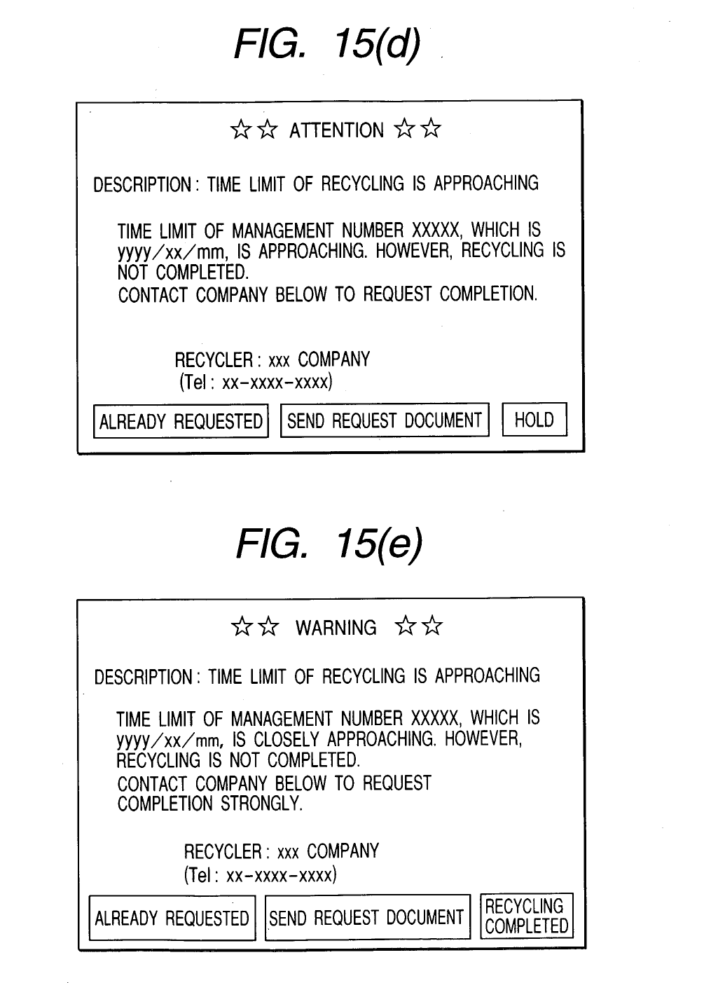

It is to be noted that in step 206 of FIG. 2, sending receipt information from the first recycler to the manufacturer permits the warning window shown in FIG. 15(a) to output in the manufacturer. FIGS. 15(a) to 15(e) illustrate examples of windows displayed on a display unit of the manufacturer.

FIG. 15(a) is a warning window displayed when an unscheduled product has arrived.

FIG. 15(b) is a warning window displayed when a scheduled product is not delivered yet. FIG. 15(c) is a warning window displayed when arrived items differ from the items that have been informed beforehand. FIG. 15(d) is an attention window displayed when time limit of recycling of a product is approaching. FIG. 15(e) is a warning window displayed when time limit of recycling of a product is approaching. If the warning window as shown in FIG. 15(a) is output to the manufacturer, a function of presenting, to the manufacturer, contact information of the discarder that discarded the unscheduled product is provided so that the manufacturer can send an inquiry document to the discarder. This function can be realized using the contact information database as shown in FIG. 4(e). Providing a function of sending an inquiry document to the discarder permits the discarder to be easily notified that an unscheduled product has arrived. Moreover, if a function that allows continuation of work through discarder's operation is included in the document, even when a product that differs from initial recycling information is discarded, the discarder's operation permits the recycling to be continued. A specific method is that a function of accessing a given area of the management system through discarder's operation is included in a document to be sent to the discarder. If an access to the area is detected, this indicates that the discarder wants to continue the recycling of the unscheduled product. More specifically, embedding a link to access a given URL in electronic mail is one of the methods. In this case, a recycling charge corresponding to the actual recycling can be charged by updating the database shown in FIG. 4(a), which stores the initial entrustment information, to actual receipt information. In a document to be sent to the discarder, it is desirable to describe a confirmation message to the effect that if continuation of recycling is selected, its charge will also be changed in accordance with the number of actually recycled items.

According to this method, when an unscheduled product arrives, recycling can be stopped. In addition to this, if recycling of an unscheduled product, the arrival of which has not been stopped, is added, the added product can be discriminated from the contracted products before the recycling, which saves the trouble of collecting its recycling charge. Further, it is also possible to efficiently notify the recycler of the arrival of an unscheduled product to confirm the recycling of the unscheduled product. Accordingly, the recycling of the unscheduled product is seldom delayed in the first recycler.

Moreover, in the flowcharts as shown in FIGS. 2, 12, 13, when the manufacturer or the discarder instructs the first recycler to recycle a product, not only a management number and details on the product but also the date and time of arrival is included as the instruction. Instructing the recycling in this manner assists the first recycler to make a work plan. The first recycler stores the scheduled date and time of arrival, which has been received, in a storage device together with the management number.

In the case of a product that does not arrive at or after the scheduled date and time of arrival, there is the possibility that the recycling is not properly performed, for example, the product does not arrive at the first recycler because the product is lost during transportation. For this reason, the processor 21 of the first recycler extracts products, which have not arrived after the scheduled date time of arrival, from the products to be recycled stored in the storage device 24. Then, as shown in FIG. 14(b), a warning to the effect that the product is not delivered yet is displayed on the display unit 22 using the management number of the product. This enables the administrator and the operator of the first recycler to investigate the product having the displayed management number. FIG. 14(b) illustrates an example of a window that also displays contact information of a company involved in the recycling. Thus, enabling the administrator and the operator to perform the investigation easily, allowing on-the-spot entry of the product that has already arrived, and other devises permit the administrator and the operator to do work smoothly. As shown in FIG. 14(b), contact information of a company involved is displayed in the warning window in a manner as described below. To begin with, information on a requester, etc. is added to data of each product to be recycled shown in FIG. 5(a). Next, a database that manages contact information on a requester basis is provided as shown in FIG. 5(f), and thereby data is extracted from the database on the basis of the relations. This method can be realized by standard work of the relational database. It is to be noted that extraction of a product whose the arrival is delayed or a warning against the delay is displayed one day after the scheduled date of arrival or several hours after the scheduled time of arrival. This can prevent a product whose the arrival is a little delayed due to congested traffic conditions, etc., and a product that is a little delayed because of delay in work or entry in the first recycler from being extracted and warned.

It should be noted that in the flowchart shown in FIG. 2, the receipt information may be sent from the first recycler to the manufacturer so that the warning window as shown in FIG. 15(b) is output to the manufacturer. In this case, if contact information of the discarder is presented using the database shown in FIG. 4(e), and if a function of sending an inquiry document to the discarder is provided, the manufacturer can easily inquire of the discarder about the delayed arrival of the scheduled product to be recycled. Moreover, if a function that enables specifications of “cancel discard” and “postpone the date of discard” in an inquiry document through discarder's operation is provided, it is possible to easily cancel the recycling entrustment of the product whose the arrival is delayed and to easily postpone the scheduled date of discard. A specific method is that a function of accessing a given area of the management system through discarder's operation is included in a document to be sent to the discarder. To be more specific, for example, a link to a given URL (Uniform Resource Locator) is embedded in electronic mail. Judging from an access to the area, it is possible to detect that the discarder is requesting “cancel discard” or “postpone the date of discard” for the product. In this connection, if “cancel discard” or “postpone the date of discard” is detected, the database shown in FIG. 4(a) storing initial entrustment information is updated. According to the updated data, a recycling charge corresponding to the actual recycling is charged.

According to this method, it is possible to manage the arrival of an entrusted product to be recycled properly. In addition, appropriate recycling of the entrusted product to be recycled is ensured. In addition to it, the administrator can easily know companies involved in the recycling on a job basis. Accordingly, man-hours required for the investigation of a job can also be reduced.

Up to this point, the case where when the manufacturer or the discarder issues a recycling instruction to the first recycler, the recycling instruction including the scheduled date and time of arrival is issued is described. Information other than the scheduled date and time of arrival could conceivably include details on entrusted products to be recycled (for example, classification of entrusted product, the number of entrusted products, etc.) in information columns. In this case, the first recycler also stores the details on entrusted products to be recycled in the storage device 24 connected to the processor 21 together with a management number. When products arrive, a management number of the products is checked before storing the management number together with the details on the products including classification of the products, and the number of products that have arrived, using the input device 23. In the first place, the first recycler compares the inputted management number with a management number that has been sent beforehand and is stored in the storage device 24. Next, in association with the number, the first recycler compares the details on products that have arrived with details on products stored beforehand. If both of them coincide with each other, the recycling of the products becomes possible. On the other hand, if they do not coincide with each other, to be more specific, in relation to a certain management number, if details on products that are scheduled to arrive differ from details on products that have actually arrived, a warning to the effect that arrived items differ from the scheduled items is displayed. FIG. 14(c) illustrates an example of a warning displayed when arrived items differ from the scheduled items. In this case, an instruction to proceed to the next step is not allowed to be issued so that the recycling is stopped.

Additionally, in relation to a certain management number, even if details on products that have actually arrived differ from details on products that are scheduled to arrive, a function that allows an instruction of compulsory continuation of work can also be provided as shown in FIG. 15(c). If this function is provided, the operator or the administrator of the first recycler who recognizes the warning to the effect that an unscheduled product has arrived can continue the recycling after inquiring of the manufacturer and the discarder about the discrepancy. Accordingly, even if the product that differs from the scheduled one arrives, the work can be done more smoothly. As a matter of course, options including a temporary hold of the work may also be provided. Providing such options assists the administrator and the operator of the first recycler to do work more smoothly.

Advancing the options still further, as shown in the window in FIG. 15(c), an option “transmit confirmation document” may also be provided. When the administrator, or the like, selects this function, a contact address of the manufacturer that has entrusted the recycling, relating to an appropriate management number, is extracted from information in FIGS. 5(a) and 5(f). Then, a document describing that details on the products that have arrived differ from details on the entrusted products is automatically sent to the extracted address. Will of the company that has entrusted the recycling can be confirmed in this manner.

It is to be noted that in the flowchart shown in FIG. 2, the receipt information may be sent from the first recycler to the manufacturer so that the warning window as shown in FIG. 15(c) is output in the manufacturer. In this case, a function whereby contact information of the discarder of the product is presented to the manufacturer using FIG. 4(e) to send a confirmation document to the discarder is provided. This function enables the manufacturer to confirm will of the discarder. Moreover, if a function that allows continuation of work through discarder's operation is included in the confirmation document, even when a product that differs from initial entrustment information is discarded, the discarder's operation permits the recycling to be continued. This method is similar to the above-mentioned example in which an instruction that includes information on the scheduled date of arrival is issued. In this case, a recycling charge corresponding to the actual recycling result can be charged by updating the database shown in FIG. 4 (a), which stores initial entrustment information, to the latest inspection information. In this case, in the confirmation document, it is desirable to describe a confirmation message to the effect that if continuation of recycling is selected, its charge will also be changed in response to the number of actually recycled items. It is to be noted that if a recycling charge for the number of products actually recycled is described in combination, it is more useful for the judgment of the discarder. This method can be realized only by calculating the recycling charge for the number of products actually recycled to include the calculated recycling charge in a document to be sent. In this connection, if the option of compulsory recycling is selected here, the next step is not allowed to be executed instead of stopping the process proceeding to the next step.

According to this method, for each recycling job, a judgment is made as to whether or not details on scheduled products (that is to say, entrusted products) coincide with details on products that have actually arrived at the first recycler, and then the products are recycled. Accordingly, the products can be properly recycled according to the entrustment information, and how to recycle the products can also be known easily. In other words, if a product has been transported by mistake although the recycling is not requested, it is possible to prevent the product from being recycled, for example, being disassembled.

When the manufacturer or the discarder issues a recycling instruction to the first recycler, as described above, there are the case where the scheduled date and time of arrival of products to be recycled is included in an instruction, and the case where information on entrusted products to be recycled is included in an instruction. Besides the cases, when the manufacturer or the discarder instructs the first recycler to recycle products, not only a management number but also information on entrusted products to be recycled having the management number may also be included in an instruction. For example, the information on entrusted products to be recycled includes the following: simply recycling the products; in the case of a computer, destroying the computer to erase data; executing data erasing processing to erase data; obtaining an asset management number of a discarder to contact the discarder or to confirms that the asset management number coincides with the asset management number specified by the discarder; and the like.

The first recycler stores the management number, and information on entrusted products to be recycled that is indicated by the management number, in the storage device (the storage unit) 24 connected to the processor 21. Then, as soon as the recycling of the products becomes possible, the instructed processing is sequentially executed. Next, the management number and the executed processing are inputted into the input device (the input unit) 23, and then the processing executed in relation to the inputted management number is compared with the recycling information stored beforehand. If both of them coincide with each other, execution of the next processing is allowed. However, there may also be a plurality of products to be recycled in relation to one management number. In addition, there may also be a case where each classification of product requires recycling in a different manner. In this case, a different symbol is added to a position immediately after the management number, for example, on an entrusted-product classification basis, and the recycling is managed one by one by a combination of the management number and the symbol. Allowing the recycling to proceed to the next work as soon as the completion of all the entrusted recycling is confirmed permits the entrusted recycling to be properly executed on a management number basis or by a combination of a management number and a symbol.

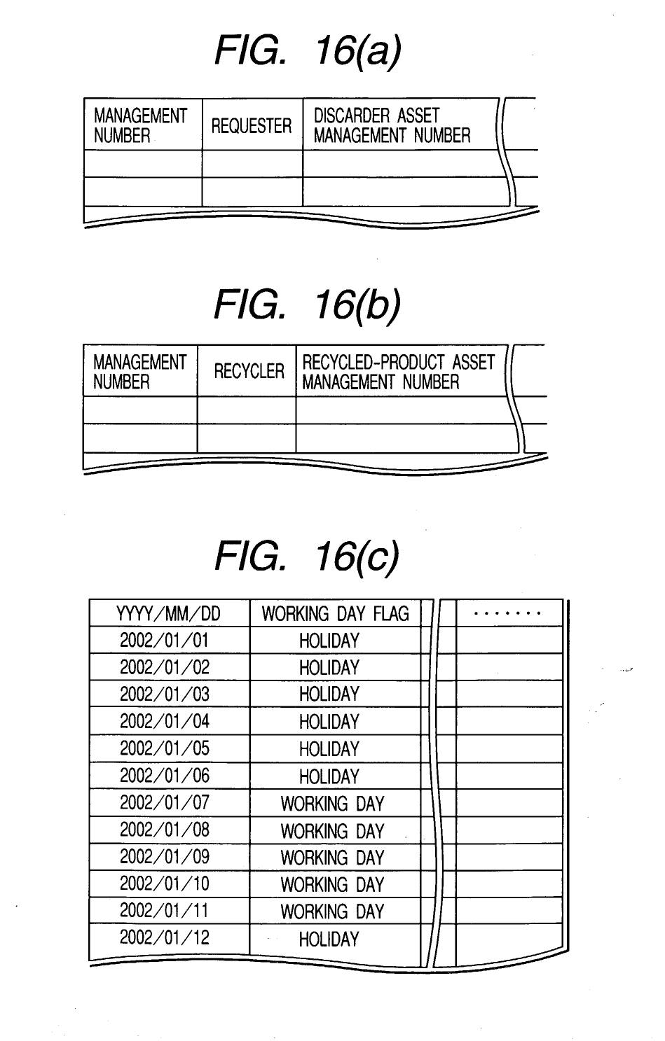

A method for providing service whereby the first recycler informs the discarder of management information on individual products such as an asset management number used on the discarder side will be described as the information on entrusted products to be recycled. In order to provide the service, as shown in FIG. 8(g), when information on individual product is entered, information on “discarder asset management number”, etc. as well as “manufacturer code”, “model name”, and “serial number” are entered. The entered information is stored in the database as shown in FIG. 5(d), and is then sent to the manufacturer. The manufacturer stores the sent information in the database as shown in FIG. 16(b), and then sends the information to the discarder that has entrusted the recycling having the management number.

FIGS. 16(a) to 16(c) illustrate table formats of the database of the manufacturer.

FIG. 16(a) is a table illustrating a discarder and a discarder asset management number that are associated with a management number.

FIG. 16(b) is a table illustrating a recycler and a discarder asset management number that are associated with a management number.

FIG. 16(c) is a table illustrating working days and holidays of the first recycler.

Here, there is a case where whether or not management information on individual products that have arrived coincide with management information on individual products specified by the discarder is checked before recycling the products. A method used in such a case will be described as an example of information on entrusted products to be recycled below. As shown in FIG. 8(g), when entering information on individual products, in addition to “manufacturer code”, “model name”, and “serial number”, information on “discarder asset management number” as an individual-product management number in the discarder is also entered. The entered information is stored in the database as shown in FIG. 5(d). Then, the first recycler checks whether or not the discarder asset management number provided by the discarder beforehand coincides with the entered discarder asset management number. It is to be noted that any of the manufacturer and the first recycler may be allowed to check whether or not the numbers coincide with each other. If the manufacturer checks the match, information about the discarder asset management number obtained by the first recycler by use of the information shown in FIG. 8(g) is stored in the database as shown in FIG. 5(d). After that, the information about the discarder asset management number, etc. is sent to the manufacturer. The manufacturer stores the information about the discarder and the discarder asset management number, which has been provided beforehand by the discarder, in the database as shown in FIG. 16(a). The information about “discarder asset management number”, etc. sent from the first recycler is stored in the database as shown in FIG. 16(b). Then, both of the databases may be compared with each other to check whether or not information associated with a management number in one database coincides with information associated with the same management number in another database.

If the first recycler checks the match, the manufacturer stores the information provided beforehand by the discarder in the database as shown in FIG. 16(a). The manufacturer provides the first recycler with this information together with recycling instruction information. The first recycler stores this information in the database as shown in FIG. 5(e). After that, the first recycler stores this information and information about “discarder asset management number” obtained from the information shown in FIG. 8(g) in the database as shown in FIG. 5(d). Then, both of the databases are compared with each other to check whether or not information corresponding to an appropriate management number in one database coincides with information corresponding to the same management number in another database.

Here, the case where recycling information on a management number basis is sent beforehand to the first recycler together with a management number has been described as an example herein. Besides this case, if recycling information is sent to the first recycler at the time of the arrival of products having the management number using a work instruction information list delivered with the products, a similar processing can be realized. In reality, when products arrived at the first recycler, a work instruction information list, which has been delivered together with the products, is inputted into the processor 21 using the input device 23 together with the products and a management number to store the inputted information in the storage device 24.

These methods make it possible to properly handle the recycling information sent before or at the time of the arrival of the products for each entrusted product to be recycled.

Next, according to an embodiment that will be described below, products that have arrived are sorted into the following two groups: products sold as valuable items; and products whose recycling is entrusted to the second recycler.

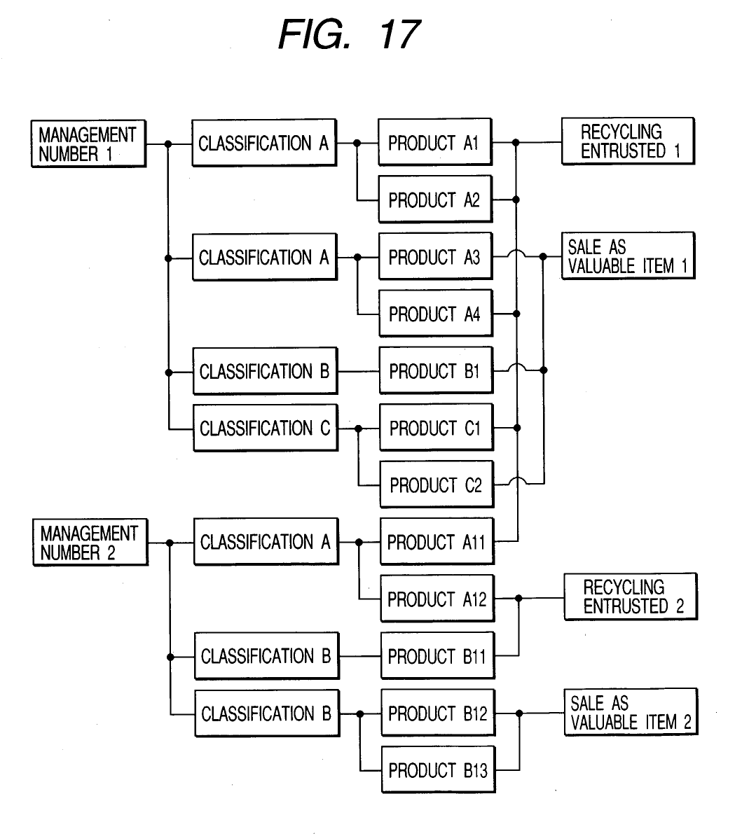

FIG. 17 is a diagram illustrating a management method in a first case of the embodiment in which products that have arrived are sorted into the two groups, products sold as valuable items, and products whose recycling is entrusted to the second recycler.

In an example shown in FIG. 17, “management number 1” has three classifications from “classification A” to “classification C”. Each classification has one or more products from among “product A1” through “product A4”, “product B1”, “product C1”, and “product C2”. In addition, “management number 2” has “classification A” and “classification B”. Each classification has one or more products from among “product A11”, “product A12”, and “product B11” through “product B13”. Further, among the products, products that can be sold as valuable items are shipped as “sale as a valuable item 1” and “sale as a valuable item 2” to a company in charge of recondition, etc. Moreover, for example, products whose recycling is entrusted to the second recycler are shipped as “recycling entrusted 1” and “recycling entrusted 2”.

The progress of recycling is reported from the second recycler by identification numbers such as “recycling entrusted 1” and “recycling entrusted 2” assigned at the time of the shipment. There are several examples of progress of recycling reported. A first example is second-recycler receipt information indicating that products whose recycling was entrusted have successfully arrived at the second recycler. A second example is second-recycler recycling completion information indicating that the second recycler has properly recycled the products whose recycling was entrusted. Besides them, a possible example is all recycling completion information indicating that products whose recycling was entrusted have been recycled to the last including the third recycler, and more, after the second recycler.

To keep track of the progress of recycling of products whose recycling is entrusted to the second recycler on a management number basis, it is necessary to manage proper delivery of the products to the second recycler and subsequent proper recycling by the second recycler. However, as regards the product treated as “sale as a valuable item”, on the assumption that the product is appropriately handled, for example, reconditioned by a company that purchases the product, no problem will be caused even if the recycling is judged to have been completed when the product has been sold or when the product enters a state in which the product can be considered to have been sold.

Here, this is applied to each management number as shown in FIG. 17. For example, in a job of the management number 1, “product A1” is shipped as “recycling entrusted 1”. In a similar manner, “product A2” is shipped as “recycling entrusted 1”; “product A3” is shipped as “sale as a valuable item 1”; “product A4” is shipped as “recycling entrusted 1”; “product B1” is shipped as “sale as a valuable item 1”; “product C1” is shipped as “recycling entrusted 1”; and “product C2” is shipped as “sale as a valuable item 1”. In this case, as regards the products belonging to “sale as a valuable item 1”, the recycling can be judged to have been appropriately completed when the products belong to it. Accordingly, the progress of recycling should be kept track of only for the products that are treated as “recycling entrusted 1”. Therefore, when second-recycler recycling completion information about the identification number “recycling entrusted 1” arrives at the first recycler, it is possible to judge that the recycling for “management number 1” has been completed. In addition, when all recycling completion information about the identification number “recycling entrusted 1” arrives at the first recycler, it is possible to judge that all the recycling for “management number 1” has been completed. On the other hand, in a job of the management number 2, “product A11” is shipped as “recycling entrusted 1”. In a similar manner, “product A12” is shipped as “recycling entrusted 2”; “product B11” is shipped as “recycling entrusted 2”; and “product B12” and “product B13” are shipped as “sale as a valuable item 2”. In this case, the recycling of the products belonging to “sale as a valuable item 2” can be judged to have been appropriately completed when the products belong to it. In addition, the products included in the job of the management number 2 belong to both of “recycling entrusted 1” and “recycling entrusted 2”. Therefore, it is necessary to keep track of the progress of recycling for both of “recycling entrusted 1” and “recycling entrusted 2”. For this reason, waiting for a report on the progress of recycling in relation to the identification numbers “recycling entrusted 1” and “recycling entrusted 2”, when second-recycler recycling completion information on both of the identification numbers arrives at the first recycler, it is judged that the recycling for “management number 2” has been completed. In addition, when all recycling completion information about both of the identification numbers arrives at the first recycler, it is judges that all the recycling for “management number 2” has been completed.

Next, a second case of the embodiment in which products that have arrived are sorted into the two groups, products sold as valuable items, and products whose recycling is entrusted to the second recycler will be described below. In the second case, similar products are managed by a combination of a management number and a sub number.

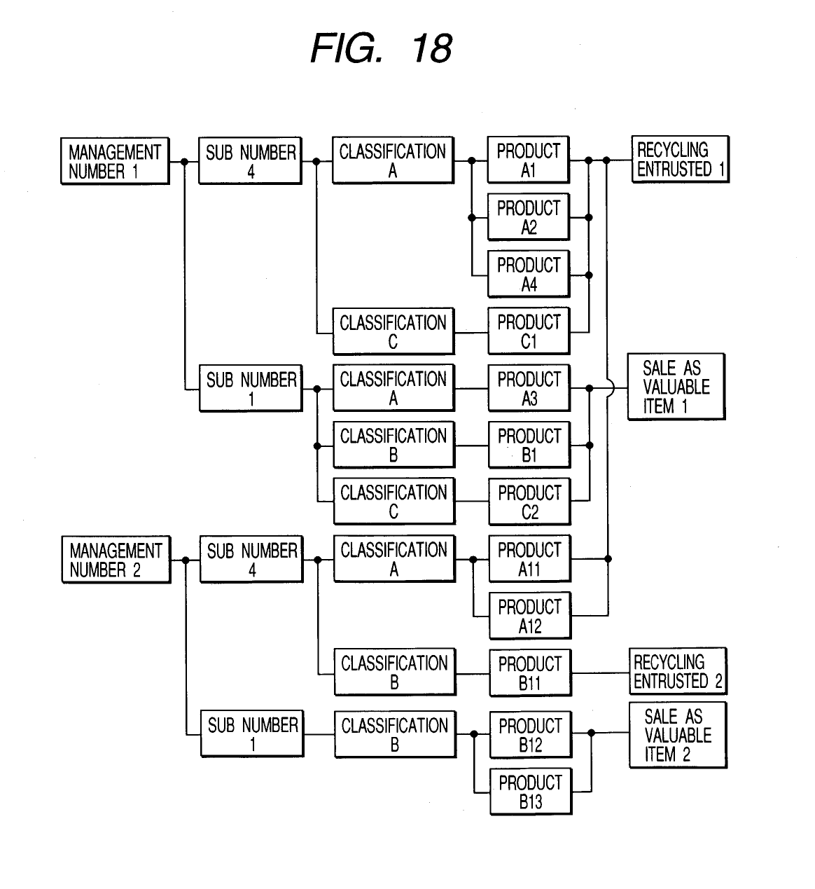

FIG. 18 is a diagram illustrating a management method in the second case of the embodiment in which products that have arrived are sorted into the two groups, products sold as valuable items, and products whose recycling is entrusted to the second recycler.

In the second case, “management number 1” is divided into “sub number 4 (recycling entrusted)” and “sub number 1 (sale as a valuable item, reuse)”. The “sub number 4” includes “classification A” and “classification C”; and the “sub number 1” includes “classification A”, “classification B”, and “classification C”. The “classification A” of the “sub number 4” includes “product A1”, “product A2”, and “product A4”. The “classification C” of the “sub number 4” includes “product C1”. The “classification A” of the “sub number 1” includes “product A3”. The “classification B” includes “product B1”. The “classification C” includes “product C2”. In a similar manner, “management number 2” is divided into “sub number 4 (recycling entrusted)” or “sub number 1 (sale as a valuable item, reuse)”. The “sub number 4” includes “classification A” and “classification B”. The “sub number 1” includes “classification B”. The “classification A” of the “sub number 4” includes “product A11”. The “classification B” includes “product B11”. The “classification B” of the “sub number 1” includes “product B12” and “product B13. Here, each product sorted as the “sub number 1 (sale as a valuable item, reuse)” can be sold as a valuable item. Accordingly, the product sorted as the “sub number 1 (sale as a valuable item, reuse)” are shipped as “sale as a valuable item 1” and “sale as a valuable item 2” to the company in charge of recondition, etc. The recycling of the products sorted as the “sub number 4” is entrusted to the second recycler. This means that the products sorted as the “sub number 4” are shipped as “recycling entrusted 1” and “recycling entrusted 2” to the second recycler.

Here, the progress of recycling is reported from the second recycler by use of identification numbers such as “recycling entrusted 1” and “recycling entrusted 2” assigned at the time of the shipment. Examples of the progress of recycling to be reported could conceivably include, as is the case with the first case, second-recycler receipt information, second-recycler recycling completion information, and all recycling completion information. As regards the product treated as “sale as a valuable item”, even if it is judged that the recycling of the product has been completed when the product has been sold or when the product enters a state in which the product can be considered to have been sold, no problem will be caused. This is also a similar point.

Each of the management numbers shown in FIG. 18 will be reviewed as below. In a job of the management number 1, “sub number 1” and “sub number 4” are shipped as “sale as a valuable item 1” and “recycling entrusted 1” respectively. In this case, as regards the products belonging to “sale as a valuable item 1”, the recycling can be judged to have been appropriately completed when the products enter a state in which they can be considered to have been sold. Accordingly, the progress of recycling should be kept track of only for the products that are treated as “recycling entrusted 1”. Therefore, when second-recycler recycling completion information about the identification number “recycling entrusted 1” arrives at the first recycler, it is possible to judge that the recycling for “management number 1” has been completed. Otherwise, when all recycling completion information about the identification number “recycling entrusted 1” arrives at the first recycler, it is possible to judge that all the recycling for “management number 1” has been completed. On the other hand, in a job of the management number 2, “sub number 1”, “classification A of sub number 4”, and “classification B of sub number 4” are shipped as “sale as a valuable item 2”, “recycling entrusted 1”, and “recycling entrusted 2”, respectively. In this case, the recycling of the products belonging to “sale as a valuable item 2” can be judged to have been appropriately completed when the products enter a state in which the product are considered to have been sold. Besides them, the job of the management number 2 has products belonging to both of “recycling entrusted 1” and “recycling entrusted 2”. The progress of recycling should be kept track of in relation to both of “recycling entrusted 1” and “recycling entrusted 2”. For this reason, the first recycler waits for a report on the progress of recycling in relation to the identification numbers “recycling entrusted 1” and “recycling entrusted 2”. Then, when second-recycler recycling completion information on both of the identification numbers arrives at the first recycler, it is possible to judge that the recycling for “management number 2” has been completed. In addition, when all recycling completion information about both of the identification numbers arrives at the first recycler, it is possible to judge that all the recycling for “management number 2” has been completed.

Thus, there are the method for managing the recycle on an individual product basis, and the method in which the recycling is managed after sorting products on a sub number basis or a classification basis. However, a way of thinking is similar. Having information that associates receipt of products with shipment of the products in the first recycler enables the first recycler to manage the progress of recycling for each receipt of products. This also works in a similar manner in the undermentioned case.

The first recycler provides the manufacturer (in the case of FIG. 2) or the discarder (in the case of FIG. 13) with the progress of recycling obtained on a management number basis. This enables the manufacturer or the discarder to keep track of the progress of recycling for the entrusted recycling job. In the example of FIG. 2, providing the discarder with information by the manufacturer enables the discarder to keep track of the progress of recycling. At this time, using information about a contract number associated with a management number, which is obtained when the manufacturer is entrusted with the recycling from the discarder, the manufacturer communicates with the discarder using the contract number.

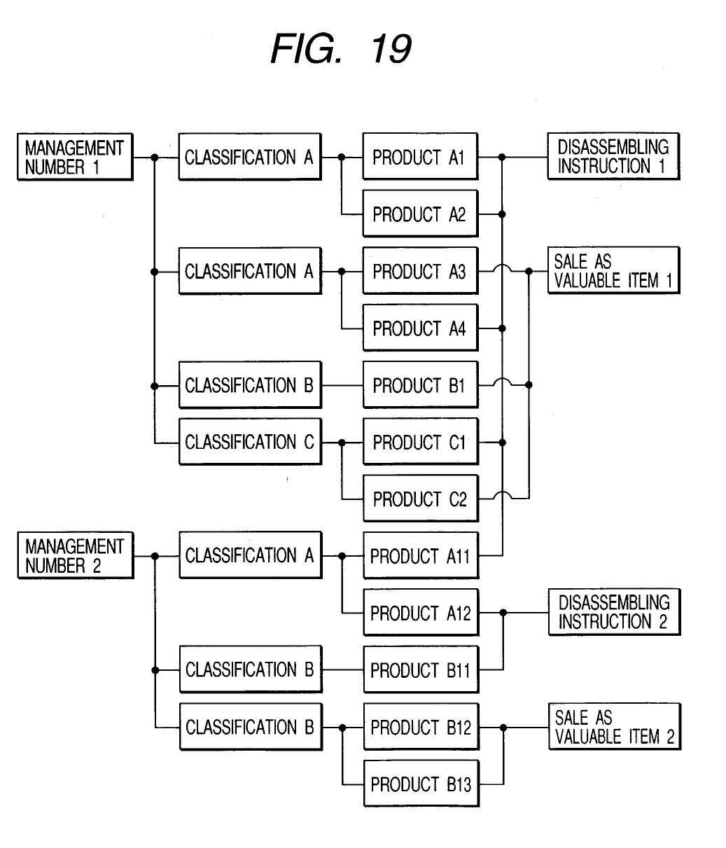

Next, a management method in which the first recycler sorts out products that have arrived into products to be sold as valuable items and products to be recycled such as disassembling will be described with reference to FIG. 19.

FIG. 19 is a diagram illustrating a method for managing an entrusted job in which products that have arrived are sorted out into products to be sold as valuable items and products to be recycled such as disassembling.

Although no sub number is used in this embodiment, a sub number may also be added to a management number as shown in FIG. 18.

In this example, “management number 1” has three classifications “classification A” through “classification C”. The “classification A” includes “product A1” and “product A2”. The next “classification A” includes “product A3” and “product A4”. The “classification B” includes “product B1”. The “classification C” includes “product C1” and “product C2”. In addition, “management number 2” has “classification A” and “classification B”. The “classification A” includes “product A11” and “product A12”. The “classification B” includes “product B11”. The “classification B” includes “product B12” and “product B13”. Further, among the products, products that can be sold as valuable items are shipped as “sale as a valuable item 1” and “sale as a valuable item 2” to the company in charge of recondition, etc. Additionally, the products that cannot be sold as valuable items is instructed as “disassembling instruction 1” and “disassembling instruction 2” for disassembling.

Here, the progress of recycling is reported from a station in charge of disassembling by use of identification numbers such as “disassembling instruction 1” and “disassembling instruction 2” assigned when the disassembling is instructed. Examples of the progress of recycling to be reported could conceivably include disassembling completion information showing that the instructed disassembling has been completed.

Here, as regards the product treated as “sale as a valuable item”, even if it is judged that the recycling of the product has been completed when the product has been sold or when the product enters a state in which the product can be considered to have been sold, no problem will be caused. This is also a point similar to the above-mentioned embodiment. However, even in a case where a product is sold as a valuable item, if it is necessary to manage the sale of the product, the sale can be managed by its identification number.

Each of the management numbers shown in FIG. 19 will be reviewed as below. In a job of a management number 1, “product A1” is shipped as “disassembling instruction 1”. “Product A2” is shipped as “disassembling instruction 1”. “Product A3” is shipped as “sale as a valuable item 1”. “Product A4” is shipped as “disassembling instruction 1”. “Product B1” is shipped as “sale as a valuable item 1”. “Product C1” is shipped as “disassembling instruction 1”. “Product C2” is shipped as “sale as a valuable item 1”. In this case, the recycling of the products belonging to “sale as a valuable item 1” can be judged to have been appropriately completed when the products enter a state in which the products can be considered to have been sold. Accordingly, the progress of recycling should be kept track of only for the products that are treated as “disassembling instruction 1”. Therefore, when disassembling completion information about identification number “disassembling instruction 1” is received from the station in charge of disassembling, it is possible to judge that the recycling for the “management number 1” has been completed. On the other hand, in a job of management number 2, “product A11” is shipped as “disassembling instruction 1”. “Product A12” is shipped as “disassembling instruction 2”. “Product B11” is shipped as “disassembling instruction 2”. “Product B12” and “product B13” are shipped as “sale as a valuable item 2”. In this case, as for the products belonging to “sale as a valuable item 2”, the recycling can be judged to have been appropriately completed when the products enter a state in which the products are considered to have been sold. Besides them, the job of the management number 2 has products belonging to both of “disassembling instruction 1” and “disassembling instruction 2”. Therefore, the progress of recycling should be kept track of in relation to both of “disassembling instruction 1” and “disassembling instruction 2”. For this reason, waiting for a report on the progress of recycling in relation to the identification numbers “disassembling instruction 1” and “disassembling instruction 2”, when disassembling completion information on both of the identification numbers arrives from the position in charge of disassembling, it can be judged that the recycling for “management number 2” has been completed.

The first recycler provides the manufacturer and the discarder with the progress of recycling as a result of the management. This point is similar to the above-mentioned embodiment.

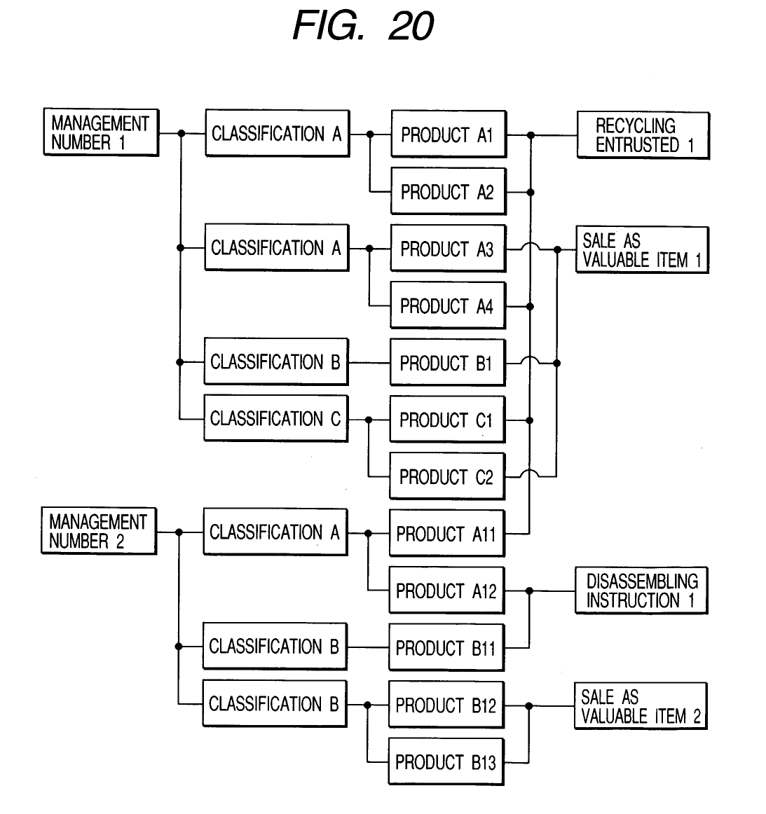

Next, a management method in which the case in FIG. 17 is combined with the case in FIG. 19 will be described with reference to FIG. 20.

In this case, products are sorted into “recycling entrusted”, “disassembling instruction”, and “sale as a valuable item” before the products are recycled.

FIG. 20 is a diagram illustrating a method for managing an entrusted job according to the embodiment in which products are sorted into “recycling entrusted”, “disassembling instruction”, and “sale as a valuable item” before the products are recycled.

Although no sub number is used in this embodiment, a sub number may also be added to a management number as shown in FIG. 18.

In this example, “management number 1” has three classifications, “classification A” through “classification C”. The “classification A” includes “product A1” and “product A2”. The next “classification A” includes “product A3” and “product A4”. The “classification B” includes “product B1”. The “classification C” includes “product C1” and “product C2”. On the other hand, “management number 2” has “classification A” and “classification B”. The “classification A” includes “product A11” and “product A12”. The “classification B” includes “product B11”. The “classification A” includes “product B12” and “product B13”. Further, among the products, products that can be sold as valuable items are shipped as “sale as a valuable item 1” and “sale as a valuable item 2” to the company in charge of recondition, etc. In addition, a product whose recycling is entrusted to the second recycler is shipped as “recycling entrusted 1”. Further, products that can not be sold as a valuable item, and that are recycled, for example, disassembled, in the first recycler, are provided with “disassembling instruction 1” so that the products are disassembled.

Here, the second recycler reports the progress of recycling by use of identification numbers such as “recycling entrusted 1” assigned at the time of the shipment. Examples of the progress of recycling to be reported could conceivably include, as is the case with the embodiment described with reference to FIG. 17 or FIG. 19, second-recycler receipt information, second-recycler recycling completion information, all recycling completion information, and disassembling completion information.

A product to be sold as a valuable item is also handled in like manner.

Each of the management numbers shown in FIG. 20 will be reviewed below. In a job of management number 1, “product A1” is shipped as “recycling entrusted 1”. “Product A2” is shipped as “recycling entrusted 1”. “Product A3” is shipped as “sale as a valuable item 1”. “Product A4” is shipped as “recycling entrusted 1”. “Product B1” is shipped as “sale as a valuable item 1”. “Product C1” is shipped as “recycling entrusted 1”. “Product C2” is shipped as “sale as a valuable item 1”. In this case, the recycling of the products belonging to “sale as a valuable item 1” can be judged to have been appropriately completed when the products enter a state in which the products can be considered to have been sold. Accordingly, the progress of recycling should be kept track of only for the products that are treated as “recycling entrusted 1”. Therefore, when second-recycler recycling completion information about the identification number “recycling entrusted 1” arrives at the first recycler, it is possible to judge that the recycling for “management number 1” has been completed. In addition, when all recycling completion information about the identification number “recycling entrusted 1” arrives at the first recycler, it is possible to judge that all the recycling for the “management number 1” has been completed. On the other hand, in a job of management number 2, “product A11” is shipped as “recycling entrusted 1”. Disassembling of “Product A12” is instructed as “disassembling instruction 1”. Disassembling of “Product B11” is instructed as “disassembling instruction 1”. “Product B12” and “product B13” are shipped as “sale as a valuable item 2”. In this case, the recycling of the products belonging to “sale as a valuable item 2” can be judged to have been appropriately completed when the products enter a state in which the product can be considered to have been sold. The products included in the job of the management number 2 belong to both of “recycling entrusted 1” and “disassembling instruction 1”. Therefore, it is necessary to keep track of the progress of recycling for both of “recycling entrusted 1” and “disassembling instruction 1”. For this reason, the first recycler waits for a report on the progress of recycling in relation to the identification numbers “recycling entrusted 1” and “disassembling instruction 1”. When second-recycler recycling completion information arrives at the first recycler, and in addition to it, when disassembling completion information arrives from the station in charge of disassembling, it is possible to judge that the recycling for the “management number 1” has been completed.

The first recycler provides the manufacturer and the discarder with the progress of recycling on a management number basis. This point is similar to the above-mentioned embodiment.

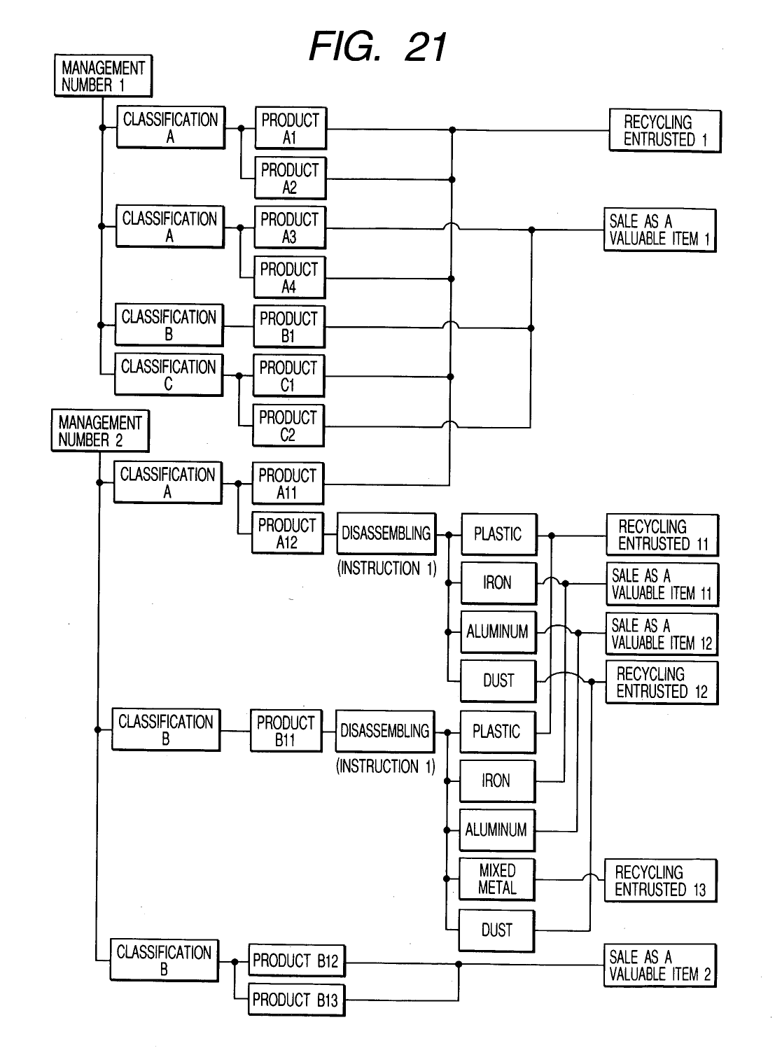

Moreover, another management method that is similar to the management method as shown in FIGS. 17 and 19 will be described with reference to FIG. 21. In this method, after products are recycled, for example, disassembled, various kinds of sorted components are also included in items to be managed.

FIG. 21 is a diagram illustrating a management method in which after products are recycled, for example, disassembled, various kinds of sorted components are also included in items to be managed.

Although no sub number is used in this embodiment, a sub number may also be added to a management number as shown in FIG. 18.

In this example, “management number 1” has three classifications, “classification A” through “classification C”.

The “classification A” includes “product A1” and “product A2”. Another “classification A” includes “product A3” and “product A4”. The “classification B” includes “product B1”. The “classification C” includes “product C1” and “product C2”. On the other hand, “management number 2” has “classification A” and “classification B”. The “classification A” includes “product A11” and “product A12”. The “classification B” includes “product B11”. Another “classification B” includes “product B12” and “product B13. Each product that can be sold as a valuable item is shipped as “sale as a valuable item 1” or “sale as a valuable item 2” to the company in charge of recondition, etc. In addition, for example, products whose recycling is entrusted to the second recycler are shipped as “recycling entrusted 1”. Products that can not be sold as a valuable item, and that are recycled, for example, disassembled, in the first recycler, are provided with “disassembling instruction 1” so that the products are disassembled.

Here, after the products are recycled, for example, disassembled, the products are sorted into various kinds of components. The sorted components differ depending on the classification of a product. FIG. 9 illustrates how to manage components as an example. FIG. 9 illustrates how to manage components when personal computers are taken as an example. In the database shown in FIG. 9, which is designed to manage components, a first column is a product classification, a second column is a component, and a third column is a flag that indicates a shipment attribute of a component in the second column, a value of which is either “valuable” or “charged”. “Product A12” of the “classification A” is disassembled into “plastic”, “iron”, “aluminum”, and “dust”. “Product B11” of the “classification B” is disassembled into “plastic”, “iron”, “aluminum”, “mixed metal”, and “dust” according to the database. As shown in FIG. 21, “product A12” is disassembled into “plastic”, “iron”, “aluminum”, and “dust”. In addition, “product B11” is disassembled into “plastic”, “iron”, “aluminum”, “mixed metal”, and “dust”. Components are gathered after the products have been recycled, for example, disassembled. Then, each component is provided with an identification symbol such as “recycling entrusted 11”, “sale as a valuable item 11”, “sale as a valuable item 12”, “recycling entrusted 12”, and “recycling entrusted 13”. After that, the recycling of the components is entrusted to the second recycler, or is shipped to the company in charge of recondition, etc.

Here, the progress of recycling is reported from the station in charge of disassembling by use of an identification number such as “disassembling instruction 1” assigned when the disassembling is instructed. Examples of progress of recycling to be reported could conceivably include disassembling completion information, second-recycler receipt information, second-recycler recycling completion information, and all recycling completion information.

Here, when the progress of recycling is kept track of on a management number basis, it is necessary for the first recycler to manage a product whose disassembling instruction is issued to the station in charge of disassembling including the progress of recycling thereof. Additionally, it is necessary to manage a product whose recycling is entrusted to the second recycler (“recycling entrusted”) or a component coming out from the recycling such as disassembling so that it is properly delivered to the second recycler and is then properly recycled. On the assumption that a product treated as “sale as a valuable item” is purchased and properly processed, for example subjected to recondition by a purchaser, no problem will be caused even if the recycling is judged to have been completed when the product has been sold or when the product enters a state in which the product can be considered to have been sold.

Each of the management numbers shown in FIG. 21 will be reviewed as below. In a job of management number 1, “product A1” is shipped as “recycling entrusted 1”. “Product A2” is shipped as “recycling entrusted 1”. “Product A3” is shipped as “sale as a valuable item 1”. “Product A4” is shipped as “recycling entrusted 1”. “Product B1” is shipped as “sale as a valuable item 1”. “Product C1” is shipped as “recycling entrusted 1”. “Product C2” is shipped as “sale as a valuable item 1”. In this case, the recycling of the products belonging to “sale as a valuable item 1” can be judged to have been appropriately completed when the products can be considered to have been sold. Accordingly, the progress of recycling should be kept track of only for the products that are treated as “recycling entrusted 1”. Therefore, when the first recycler receives second-recycler recycling completion information about the identification number “recycling entrusted 1”, it is possible to judge that the recycling for the “management number 1” has been completed. In addition, when all recycling completion information about the identification number “recycling entrusted 1” arrives at the first recycler, it is possible to judge that all the recycling for the “management number 1” has been completed. On the other hand, in a job of management number 2, “product A11” is shipped as “recycling entrusted 1”. Disassembling of “Product A12” is instructed as “disassembling instruction 1”. Disassembling of “Product B11” is instructed as “disassembling instruction 1”. “Product B12” and “product B13” are shipped as “sale as a valuable item 2”. Moreover, according to the “disassembling instruction 1”, “product A12” and “product B11” are each disassembled into components. The components are shipped as “recycling entrusted 11”, “sale as a valuable item 11”, “sale as a valuable item 12”, “recycling entrusted 12”, and “recycling entrusted 13”. In this case, the recycling of the products belonging to “sale as a valuable item 2”, “sale as a valuable item 11”, and “sale as a valuable item 12” can be judged to have been appropriately completed at the time when the products can be considered to have been sold. Since there are components shipped as “recycling entrusted 1” and “disassembling instruction 1”, it is necessary to manage the progress of recycling by keeping track of all of “recycling entrusted 1”, “recycling entrusted 11”, “recycling entrusted 12”, and “recycling entrusted 13”.For this reason, the first recycler waits for a report on the progress of recycling in relation to the identification numbers “recycling entrusted 1”, “recycling entrusted 11”, “recycling entrusted 12”, and “recycling entrusted 13”, when the first recycler receives second-recycler recycling completion information, it is possible to judge that the recycling for the “management number 1” has been completed. Here, looking at each classification, the “classification A” belonging to the “management number 2” leads to “recycling entrusted 1”, “recycling entrusted 11”, “sale as a valuable item 11”, “sale as a valuable item 12”, and “recycling entrusted 12”. The “classification B” leads to “recycling entrusted 11”, “sale as a valuable item 11”, “sale as a valuable item 12”, “recycling entrusted 12”, “recycling entrusted 13”, and “sale as a valuable item 2”. Therefore, the “classification A” waits for a report on the progress of recycling in relation to all of “recycling entrusted 1”, “recycling entrusted 11”, and “recycling entrusted 12”. Subsequently, when the first recycler receives second-recycler recycling completion information about them, the recycling is considered to have been completed. In a similar manner, the recycling of the “classification B” can be considered to have been completed when the first recycler receives second-recycler recycling completion information about “recycling entrusted 11”, “recycling entrusted 12”, and “recycling entrusted 13”.

The first recycler provides the manufacturer and the discarder with the progress of recycling on a management number basis. This point is similar to the above-mentioned embodiment.

According to these methods, even when part of the entrusted recycling is further entrusted to the second recycler, the identification number assigned when the recycling is entrusted to the second recycler can be associated with the management number assigned when the first recycler was entrusted with the recycling. Accordingly, using recycling result information by an identification number obtained from the second recycler, it becomes possible to notify the discarder of the progress of recycling associated with the management number assigned when the discarder entrusted the recycling.

Up to this point, information exchange between the first recycler and the second recycler, and a flow of managed information in the first recycler have been described as examples. However, even if there are the third recycler, and more, after the second recycler, it is possible to perform similar processing by regarding the second recycler as the first recycler of this embodiment, and by regarding the third recycler as the second recycler of this embodiment.

Next, a method for completing the recycling within a period of time stipulated by a regulation or a contract will be described with reference to FIGS. 2 and 4.

As shown in FIG. 4(a), a database capable of storing a management number, the start date of recycling of the management number, and the completion date of recycling of the management number is provided to manage the progress of recycling on a management number basis. Additionally, as shown in FIG. 16(c), a database for managing standard working days and holidays is provided.

An example of processing will be described below.

In the first place, jobs whose the start date of recycling is stored and whose the completion date of recycling is not stored are extracted from the database shown in FIG. 4(a). This extraction work is performed at regular intervals, for example, once a day. Next, for each of the jobs extracted, a time limit (day) at which a period of time stipulated by a regulation or a contract expires is calculated on the basis of the start date of recycling. For example, if the start date of recycling is Oct. 1, 2001 and a period of time is 90 days, the time limit is Jan. 9, 2002. Here, to ensure that the recycling is completed on Jan. 9, 2002, an attention window or a warning window as shown in FIG. 15(d) or 15(e) respectively is displayed at a given period of time before the time limit. This urges an administrator and a person in charge of the recycling to complete the recycling before the time limit. A method for displaying the attention window or the warning window is that, when it is still possible to spend enough time until the time limit, the attention window is displayed, for example, twenty days before. At this point of time, a judgment is made as to how to cope with this, send a request to hasten the recycling, or hold such a request. After that, when the time limit of the recycling closely approaches, for example, ten days before the time limit, the warning window is displayed. At this point of time, it is desirable to provide a means for properly accomplishing the recycling.

Further, in the windows as shown in FIGS. 15(d) and 15(e), an option of “Send request document” is provided. When the administrator or the like selects this function, contact information of the first recycler, which is entrusted with the recycling having an appropriate management number, is extracted using FIG. 4(e). After that, a document notifying that the recycling is delayed is automatically sent to a place indicated by the contact information extracted. Thus, urging the entrusted company to hasten the recycling work becomes possible. Moreover, the request document is provided with a function that enables the entrusted company to send back information about the possibility that the recycling will be completed. As a result, the entrusted recycler can manage the progress of recycling. Examples of specific methods for realizing this include a method in which a link to access a predetermined URL is embedded in electronic mail according to the time at which the completion of recycling is expected. In this manner, a different area of the management system is accessed according to the time at which the completion of the recycling is expected. Examples of the option to select the time could conceivably include the following: the recycling has been completed; the recycling will be completed tomorrow; the recycling will be completed the day after tomorrow; the recycling will be completed within 5 days; and the recycling will be completed within 10 days. Accordingly, detecting an access to the area enables the entrusted recycler to manage the progress of recycling.

It is to be noted that as shown in FIGS. 14(d) and 14(e), it is also desirable to display the attention window and the warning window, which are displayed for managing time limits, on the first recycler side. In this case, information on the second recycler that is entrusted with the recycling is displayed on the first recycler side using FIGS. 5(a) and 5(f). Then, according to the displayed information, the first recycler sends the second recycler a document such as a request document.

Regardless of a company that recycles a product, it is desirable to determine a time limit on a calendar day basis counting from the start date of recycling. On the other hand, when determining the period of time that can be spent before displaying an attention message or a warning, it is desirable to take working days and holidays into consideration instead of simply using calendar days. For example, as shown in FIG. 16(c), a database for managing standard working days and holidays is provided. Then, a period of time that can be spent is determined by counting only working days. Consequently, after requesting the ship-to company for the actual recycling work, the given number of days can be kept until the time limit. To be more specific, as shown in FIG. 16(c), even if there are many holidays during the period, for example, from the end to the beginning of the year, it is possible to manage time limits with sufficient time allowed.

How to set the start date of recycling will be described. The start date of recycling is set by obtaining, for example, the date on which a product is collected from a place for discard from a transportation company or a transportation department. This date can be obtained using a usual method.

According to the above-mentioned method for managing time limits, it is possible to automatically extract recycling jobs that are not completed yet although the time limit of recycling stipulated by a regulation and a law is approaching. Moreover, in relation to a recycling job that is not completed yet, the progress of recycling in the first recycler, in the second recycler, and more, is obtained so as to hasten the recycling. As a result, completion of the recycling within a predetermined period of time becomes possible. Since the recycling is requested in two stages before the time limit, that is, displaying an attention message, and displaying a warning message, smoother management of time limits becomes possible.

According to the present invention, the recycler compares a product whose the recycling is entrusted with entrustment information notified beforehand to check whether or not they coincide with each other. Accordingly, it is possible to confirm that this is a product whose recycling has been entrusted. In addition, it is possible to collect a recycling charge corresponding to the actual result of recycling.

Moreover, even when services are provided with recycling, comparing entrustment information with the result of the recycling permits the entrusted services to be properly provided.

Further, even when a product is disassembled into a plurality of components, it is possible to manage how the components are associated with entrusted jobs, which permits even the result of recycling of the components to be managed.

Furthermore, it is also possible to manage the recycling so that the recycling is completed within a period of time stipulated by a regulation and a law.

What is claimed is:

1. A recycling information management system for managing recycling of a product, comprising:
an assigning unit which assigns a management number to each recycling job;
a keeping unit which keeps track of information about a product included in a recycling job by associating the information about the product with a management number beforehand; and
a managing unit which manages recycling information about a product that has actually arrived by associating the recycling information with the management number.

2. A recycling information management system for managing recycling of a product, comprising:
an assigning unit which assigns a management number to each recycling job;
a keeping unit which keeps track of information about a product included in a recycling job by associating the information about the product with a management number beforehand; and
a checking and displaying unit which checks as to whether or not information about a product that has actually arrived coincides with information about a product that is kept track of beforehand on the basis of the management number to confirm that the product that has arrived is a scheduled product, and if an unscheduled product has arrived, displays a warning message to the effect that the unscheduled product is included by specifying an appropriate management number.

3. A recycling information management system for managing recycling of a product, comprising:
an assigning unit which assigns a management number to each recycling job;
a keeping unit which keeps track of information about a product included in a recycling job by associating the information about the product with a management number beforehand; and
a checking and displaying unit which checks as to whether or not information about a product that has actually arrived coincides with information about a product that is kept track of beforehand on the basis of the management number to confirm that the product that has arrived is a scheduled product, and if a scheduled product has not arrived, displays a warning message to the effect that the scheduled product is not delivered yet by specifying an appropriate management number.

4. A recycling information management system for managing recycling of a product, comprising:
an assigning unit which assigns a management number to each recycling job;
a keeping unit which keeps track of information about a product included in a recycling job by associating the information about the product with a management number beforehand; and
a checking and displaying unit which checks as to whether or not information about a product that has actually arrived coincides with information about a product that is kept track of beforehand on the basis of the management number, and if the information does not coincide with each other, displays a warning message to the effect that the information about the product arrived does not coincide with the information about the product that is kept track of beforehand by specifying an appropriate management number.

5. A recycling information management system for managing recycling of a product according to claim 4, wherein said recycling information management system consists of a system of a requester which entrusts the recycling and a system of a recycler that is entrusted with the recycling, and said system on the recycler side comprises a sending unit which automatically sends, to the system on the requester side, a document to the effect that information does not coincide with each other, said document being used as the warning message to be displayed.

6. A recycling information management system for managing recycling of a product according to claim 5, wherein said system of the recycler comprises:
a sending unit which sends back a result of judgment made by the requester about a discrepancy in information, said result of judgment being included in the document that is automatically sent to the requester; and
a judging unit which judges recycling information according to a reply received.

7. A recycling information management system for managing recycling of a product, comprising:
an assigning unit which assigns a management number to each recycling job;
a keeping unit which keeps track of information about a product included in a recycling job by associating the information about the product with a management number beforehand, said association including a service required for the product;
a storing unit which stores a service actually performed in relation to the product by associating the service actually performed with the management number; and
a comparing unit which compares the service kept track of beforehand with the service actually performed.

8. A recycling information management system for managing recycling of a product, comprising:
an assigning unit which assigns a management number to each recycling job;
an information keeping unit which keeps track of information about a product included in a recycling job by associating the information about the product with a management number beforehand;
a service keeping unit which keeps track of a service required to be performed for the product before the product arrives according to the management number;
a storing unit which stores the service that has been actually performed for the product arrived; and
a comparing unit which compares the service kept track of beforehand with the service actually performed and stored.

9. A recycling information management method used by a recycler, comprising the steps of:
extracting an individual product identification number on a requester side, said individual product identification number being assigned to a product to be recycled;
presenting the individual product identification number to the requester; and
obtaining, from the requester, a value calculated according to the individual product identification number.

10. A recycling information management system for managing recycling of a product, comprising:
a system of a requester which entrusts the recycling; and
a system of a recycler that is entrusted with the recycling;
wherein said recycling management system on the recycler side comprises:
an extracting and confirming unit which extracts an individual product identification number on the requester side, which is assigned to a product arrived that should be recycled, and confirms that the extracted individual product identification number coincides with an individual product identification number sent from the requester beforehand; and
an allowing unit which allows the recycling of a product if the extracted individual product identification number of the product coincides with a corresponding individual product identification number sent beforehand.

11. A recycling information management method used by a recycler, comprising the steps of:
extracting an individual product identification number on a requester side, said individual product identification number being assigned to a product to be recycled;
confirming that the extracted individual product identification number coincides with an individual product identification number sent from the requester beforehand;
allowing the recycling of a product if the extracted individual product identification number of the product coincides with a corresponding individual product identification number sent beforehand; and
obtaining, from the requester, a value calculated according to the individual product identification number.

12. A recycling information management system for managing recycling of a product, comprising:
a keeping unit which keeps track of information about a product to be recycled by associating the information about the product with a management number;
a judging, assigning and entrusting unit which makes a judgment as to whether or not the product is reusable on a product basis, assigns an identification number associated with the management number to each product according to the result of the judgment, and entrusts the product to the next company; and
an associating unit which associates information sent from the entrusted company with the identification number to manage the information.

13. A recycling information management system for managing recycling of a product, comprising:
an assigning unit which assigns a management number to each recycling job;
a keeping unit which keeps track of information about a product included in a recycling job by associating the information about the product with the management number;
a judging and assigning unit which makes a judgment as to whether or not the product is reusable, and as a result of the judgment, if it is judged that the product is not reusable, assigns an identification number to each component after the recycling; and
a managing unit which manages the progress of recycling in association with the identification number.

14. A management system of a recycler that recycles a product, said management system comprising:
an assigning unit which assigns a management number to each recycling job;
a managing unit which manages information about a product included in a recycling job by associating the information about the product with a management number;
a judging and assigning unit which makes a judgment as to whether or not the product to be recycled is usable on a product basis, and according to the result of the judgment, assigns an identification number associated with the management number to each component after the recycling; and
an accepting and identifying unit which accepts a report on the recycling sent from a department in charge of recycling in association with the identification number, and identifies the report on the recycling number associated with a management number by the association of the identification number with the management number.

15. A management system of a recycler that recycles a product, comprising:
an assigning unit which assigns a management number to each recycling job;
a managing unit which manages information about a product included in a recycling job by associating the information about the product with a management number; and
a judging, assigning and accepting unit which making a judgment as to whether or not a product arrived is reusable, and according to the result of the judgment, assigns an identification number associated with the management number to each product so as to entrust the product to a department in charge of the recycling, and accepts a report on the recycling from the department in charge of the recycling in association with the identification number.

16. A recycling information management system for managing recycling of a product, comprising:
an assigning unit which assigns a management number to each recycling job;
a managing unit which manages information about a product included in a recycling job by associating the information about the product including a start date of recycling with a management number; and
a displaying unit which if the recycling is not completed by a given period of time before a predetermined time limit, displays an attention message or a warning message so as to request hastening of the recycling.
